(19) United States
(12) Patent Application Publication
(10) Pub. No.: US 2017/0282856 A1
(43) Pub. Date: Oct. 5, 2017

(54) WIRELESS KEYLESS ENTRY SYSTEMS AND METHODS

(71) Applicant: Analog Devices, Inc., Norwood, MA (US)

(72) Inventors: William R. Riedel, North Andover, MA (US); Harvey Weinberg, Sharon, MA (US)

(21) Appl. No.: 15/477,373

(22) Filed: Apr. 3, 2017

Related U.S. Application Data
(60) Provisional application No. 62/317,876, filed on Apr. 4, 2016.

(51) Int. Cl. B60R 25/24; B60R 25/25

(52) U.S. Cl. CPC B60R 25/24; B60R 25/25

(57) ABSTRACT

Wireless keyless entry systems for automotive vehicles that employ activity, fitness, biometric, and/or proximity data for identifying authorized system users and/or personalizing, tailoring, or controlling operational aspects of the automotive vehicles. The wireless keyless entry systems are configured to be worn by system users as wearable key fobs, allowing the wireless keyless entry systems to detect motions of the system users, monitor biometric data from the system users, as well as determine proximities of the system users relative to the respective automotive vehicles. By employing such activity, fitness, biometric, and/or proximity data for authorized system user identification and/or automotive vehicle operational control, the disclosed wireless keyless entry systems can enhance the security, safety, and convenience of automotive vehicle operators.

### CROSS-REFERENCE TO RELATED APPLICATIONS

This application claims benefit of the priority of U.S. Provisional Patent Application No. 62/317,876 filed Apr. 4, 2016 entitled WIRELESS KEYLESS ENTRY SYSTEMS AND METHODS.

### FIELD OF THE DISCLOSURE

The present application relates generally to wireless keyless entry systems for automotive vehicles, and more specifically to wireless keyless entry systems configured as wearable key fobs operative to employ activity, fitness, biometric, and/or location data for identifying authorized operators of automotive vehicles, as well as for personalizing, tailoring, and/or controlling operational aspects of such automotive vehicles.

### BACKGROUND

In recent years, wireless keyless entry systems for automotive vehicles have gained widespread popularity. Conventional wireless keyless entry systems for automotive vehicles have traditionally been implemented within key fobs attachable to key rings or key chains, or within handles of ignition keys for such automotive vehicles. A typical key fob or ignition key handle can include a number of pushbuttons and corresponding electronics operative to control various functions of the wireless keyless entry systems, such as locking/unlocking one or more doors of an automotive vehicle, opening a trunk or tailgate of the automotive vehicle, activating an alarm on the automotive vehicle, as well as starting the automotive vehicle's engine.

While some early wireless keyless entry systems for automotive vehicles employed infrared (IR) signals to communicate with receiver units deployed in such automotive vehicles, many newer wireless keyless entry systems employ radio frequency (RF) signals instead of IR signals. Such wireless keyless entry systems can transmit and receive RF signals (typically at 433 MHz and 125 kHz, respectively) with identity codes that correspond to the respective wireless keyless entry systems. Further, such receiver units deployed in automotive vehicles are typically programmable, and can be programmed by automotive vehicle dealers to recognize the identity codes transmitted in RF signals by the wireless keyless entry systems. Upon valid recognition of the respective identity codes, the vehicle receiver units can implement desired vehicle operational functions, including locking/unlocking one or more doors, opening a trunk or tailgate, activating an alarm, and/or starting the engine of an automotive vehicle.

### SUMMARY OF THE DISCLOSURE

In accordance with the present application, wireless keyless entry systems for automotive vehicles are disclosed that employ activity, fitness, biometric, and/or location data for identifying authorized operators of the automotive vehicles, determining proximities of the wireless keyless entry systems to the respective automotive vehicles, determining biometric states of system users, as well as for personalizing, tailoring, and/or controlling operational aspects of the automotive vehicles based at least on such authorized operator identifications and/or proximity/biometric state determinations. The disclosed wireless keyless entry systems are configured to be worn by the system users as wearable key fobs, allowing the wireless keyless entry systems to detect motions of the system users, monitor biometric data gathered from the system users, and determine geographical locations of the system users. The disclosed wireless keyless entry systems are operative to perform data fusions on location data gathered from the wireless keyless entry systems and/or the respective automotive vehicles, as well as motion data and/or the biometric data gathered from the system users, in order to infer (1) that the system users are authorized operators of the respective automotive vehicles, (2) that the system users are near, approaching, or departing from the respective automotive vehicles, (3) the system users' biometric states, (4) potential emergency conditions and/or situations pertaining to the system users, and/or (5) the system users' consumer preferences and/or behavioral patterns. By employing such activity, fitness, biometric, and/or location data in wearable key fobs, the disclosed wireless keyless entry systems for automotive vehicles can advantageously enhance the security, safety, and convenience of automotive vehicle operators.

In certain embodiments, a method of a wearable keyless entry system for an automotive vehicle is provided, in which the wearable keyless entry system includes a transmitter/receiver. The method includes placing the transmitter/receiver in a non-transmitting state, and determining whether or not a user of the wearable keyless entry system is an authorized operator of the automotive vehicle. The method further includes, in the event the user of the wearable keyless entry system is determined to be the authorized operator of the automotive vehicle, transitioning the transmitter/receiver from the non-transmitting state to a transmitting/receiving state for wirelessly communicating with vehicle electronics of the automotive vehicle, and transmitting, by the transmitter/receiver, a system identifier of the wearable keyless entry system to the vehicle electronics. The method still further includes, in the event the user of the wearable keyless entry system is determined not to be the authorized operator of the automotive vehicle, maintaining the transmitter/receiver in the non-transmitting state.

In certain further embodiments, a method of a wearable keyless entry system for an automotive vehicle is provided, in which the wearable keyless entry system includes a transmitter/receiver, and a system location locator for obtaining user location data specifying one or more geographical locations of a user of the wearable keyless entry system. The method includes obtaining the user location data specifying the one or more geographical locations of the user of the wearable keyless entry system, and accessing, via the transmitter/receiver, vehicle location data from a data storage resource of a processing cloud. The vehicle location data specifies a geographical location of the automotive vehicle. The method further includes determining whether or not the user location data and the vehicle location data satisfy at least one predetermined distance criteria, and, having determined that the at least one predetermined distance criteria is satisfied by the user location data and the vehicle location data, transmitting, by the transmitter/receiver, a system identifier of the wearable keyless entry system to vehicle electronics of the automotive vehicle.

In certain additional embodiments, a method of a wearable keyless entry system for an automotive vehicle is provided that includes generating an operator profile of a user of the wearable keyless entry system. The operator profile includes at least an operator identifier of the user. The method further includes storing the operator profile in a data storage resource of a processing cloud. The data storage resource further stores a vehicle profile of the automotive vehicle. The vehicle profile includes at least one or more operator identifiers, and personalized vehicle settings corresponding to each respective operator identifier. A data fusion/decision processing resource of the processing cloud performs data fusion/decision processing on the operator profile and the vehicle profile based on the operator identifier of the user to obtain the personalized vehicle settings corresponding to the operator identifier of the user, and initiates a transmission of the personalized vehicle settings of the user to vehicle electronics of the automotive vehicle.

In certain further embodiments, a method of a wearable keyless entry system for an automotive vehicle is provided that includes generating a user profile of a user of the wearable keyless entry system. The user profile includes at least user location data and one or more of user biometric data and user motion data. The method further includes storing the user profile in a data storage resource of a processing cloud. The data storage resource further stores a vehicle profile of the automotive vehicle. The vehicle profile includes vehicle location data. A data fusion/decision processing resource of the processing cloud performs data fusion/decision processing on the user profile and the vehicle profile to determine one or more of (1) one or more destination locations of the automotive vehicle, and (2) one or more activities of the user of the wearable keyless entry system. The method still further includes receiving, at one of the wearable keyless entry system and vehicle electronics of the automotive vehicle, one or more of personalized targeted advertisement data and personalized targeted service data pertaining to one or more of the one or more destination locations and the one or more activities.

In certain additional embodiments, a wearable keyless entry system has an associated system identifier, and includes a transmitter/receiver. The transmitter/receiver is initially in a non-transmitting state. The wearable keyless entry system further includes a processor operative to determine whether or not a user of the wearable keyless entry system is an authorized operator of the automotive vehicle, and, in the event the user of the wearable keyless entry system is determined to be the authorized operator of the automotive vehicle, to transition the transmitter/receiver from the non-transmitting state to a transmitting/receiving state for wirelessly communicating with vehicle electronics of the automotive vehicle. The transmitter/receiver is operative, having transitioned to the transmitting/receiving state, to transmit the system identifier to the vehicle electronics. The processor is further operative, in the event the user of the wearable keyless entry system is determined not to be the authorized operator of the automotive vehicle, to maintain the transmitter/receiver in the non-transmitting state.

Other features, functions, and aspects of the present application will be evident from the Detailed Description that follows.

### BRIEF DESCRIPTION OF THE DRAWINGS

The accompanying drawings, which are incorporated in and constitute a part of the present application, illustrate one or more embodiments described herein, and, together with the Detailed Description, explain these embodiments. In the drawings:

FIG. 1 is a diagram illustrating a typical environment in which an exemplary wireless keyless entry system for an automotive vehicle may be employed, in accordance with the present application;

FIG. 2 is a block diagram of the wireless keyless entry system of FIG. 1;

FIG. 3 is a block diagram of exemplary telematics included in the automotive vehicle of FIG. 1;

FIG. 4 is a flow diagram of an exemplary method of operating a transmitter/receiver within the wireless keyless entry system of FIG. 1, based on a proximity of the wireless keyless entry system to the automotive vehicle of FIG. 1;

FIG. 5 is a flow diagram of a further exemplary method of operating the transmitter/receiver within the wireless keyless entry system of FIG. 1, based on a direction of movement of the wireless keyless entry system relative to the automotive vehicle of FIG. 1;

FIG. 6 is a flow diagram of an exemplary method of identifying a user of the wireless keyless entry system of FIG. 1 as an authorized operator of the automotive vehicle of FIG. 1, based on a gait signature of the user of the wireless keyless entry system;

FIG. 7 is a flow diagram of a further exemplary method of identifying the user of the wireless keyless entry system of FIG. 1 as an authorized operator of the automotive vehicle of FIG. 1, based on a heart rate signature of the user of the wireless keyless entry system;

FIG. 8a is a flow diagram of an exemplary method of performing data fusion on gait motion data and heart rate biometric data gathered from the user of the wireless keyless entry system of FIG. 1 in order to infer that the user is an authorized operator of the automotive vehicle of FIG. 1, and activating the transmitter/receiver within the wireless keyless entry system based on the inference made about the user's status as an authorized operator;

FIG. 8b is a flow diagram of an exemplary method of performing data fusion on location data pertaining to the wireless keyless entry system of FIG. 1 and location data pertaining to the automotive vehicle of FIG. 1 in order to infer that the user of the wireless keyless entry system is near, approaching, or departing from the automotive vehicle, and activating the transmitter/receiver within the wireless keyless entry system based on the inference made about the user's proximity or direction of movement relative to the automotive vehicle;

FIG. 8c is a flow diagram of an exemplary method of performing data fusion on a profile of the user of the wireless keyless entry system of FIG. 1 and a profile of the automotive vehicle of FIG. 1 in order to infer and implement personalized vehicle settings within the automotive vehicle of FIG. 1;

FIG. 9 is a flow diagram of an exemplary method of performing data fusion on gait motion data and/or heart rate biometric data gathered from the user of the wireless keyless entry system of FIG. 1, location data gathered from the wireless keyless entry system, and/or location data associated with the automotive vehicle of FIG. 1 in order to infer consumer preferences and/or behavioral patterns of the user, and providing personalized targeted advertisements and/or services to the user based on the inference made about the user's consumer preferences and/or behavioral patterns;

FIG. 10 is a flow diagram of a further exemplary method of performing data fusion on gait motion data and/or heart rate biometric data gathered from the user of the wireless keyless entry system of FIG. 1, location data gathered from the wireless keyless entry system, and/or location data associated with the automotive vehicle of FIG. 1 in order to infer a potential emergency condition or situation pertaining to the user, and providing an alert to the user or emergency services based on the inference made about the user's potential emergency condition or situation; and

FIG. 11 is a diagram of an exemplary display associated with the wireless keyless entry system of FIG. 1, illustrating operation of an exemplary software application program that depicts relative geographical locations of the user of the wireless keyless entry system and the automotive vehicle of FIG. 1.

### DETAILED DESCRIPTION

The disclosure of U.S. Provisional Patent Application No. 62/317,876 filed Apr. 4, 2016 entitled WIRELESS KEYLESS ENTRY SYSTEMS AND METHODS is hereby incorporated herein by reference in its entirety.

Wireless keyless entry systems for automotive vehicles are disclosed that employ activity, fitness, biometric, and/or location data for identifying authorized operators of the automotive vehicles, determining proximities of the wireless keyless entry systems to the respective automotive vehicles, determining biometric states of system users, as well as for personalizing, tailoring, and/or controlling operational aspects of the automotive vehicles based at least on such authorized operator identifications and/or proximity/biometric state determinations. The disclosed wireless keyless entry systems are configured to be worn by the system users as wearable key fobs, allowing the wireless keyless entry systems to detect motions of the system users, monitor biometric data gathered from the system users, and determine geographical locations of the system users relative to the respective automotive vehicles.

The disclosed wireless keyless entry systems for automotive vehicles can avoid at least some of the drawbacks of conventional wireless keyless entry systems, which often continuously transmit radio frequency (RF) signals containing identity codes that correspond to the respective conventional systems. It is known that nefarious individuals can intercept RF signals transmitted by such conventional systems, using relatively simple receiver devices. Further, the identity codes contained in such RF signals can be extracted and subsequently used by such nefarious individuals to unlock doors of automotive vehicles associated with the respective conventional systems, or otherwise gain unauthorized access to such automotive vehicles. Rather than continuously transmitting RF signals with identity codes like conventional systems, the disclosed wireless keyless entry systems can perform data fusions on location data associated with the wireless keyless entry systems and/or the respective automotive vehicles, as well as motion data and/or the biometric data gathered from the system users, in order to infer one or more of the following: (1) that the system users are authorized operators of the respective automotive vehicles, (2) that the system users are near, approaching, or departing from the respective automotive vehicles, (3) the system users' biometric states, (4) potential emergency conditions or situations pertaining to the system users, and (5) the system users' consumer preferences and/or behavioral patterns. Further, the disclosed wireless keyless entry systems can avoid transmitting RF signals containing identity codes until after the system users have been inferred as authorized operators of the automotive vehicles, and/or until after their proximity or direction of movement relative to the automotive vehicles have been inferred.

By employing activity, fitness, biometric, and/or location data in wearable key fobs to make inferences about system users' statuses as authorized operators of automotive vehicles, the disclosed wireless keyless entry systems can advantageously enhance the security of such authorized vehicle operators. Moreover, by further employing such activity, fitness, biometric, and/or location data to make inferences about authorized operators' proximities to their automotive vehicles, the authorized operators' biometric states, potential emergency conditions or situations pertaining to the authorized operators, and the authorized operators' consumer preferences and/or behavioral patterns, the disclosed wireless keyless entry systems can also advantageously enhance the safety and convenience of such authorized vehicle operators.

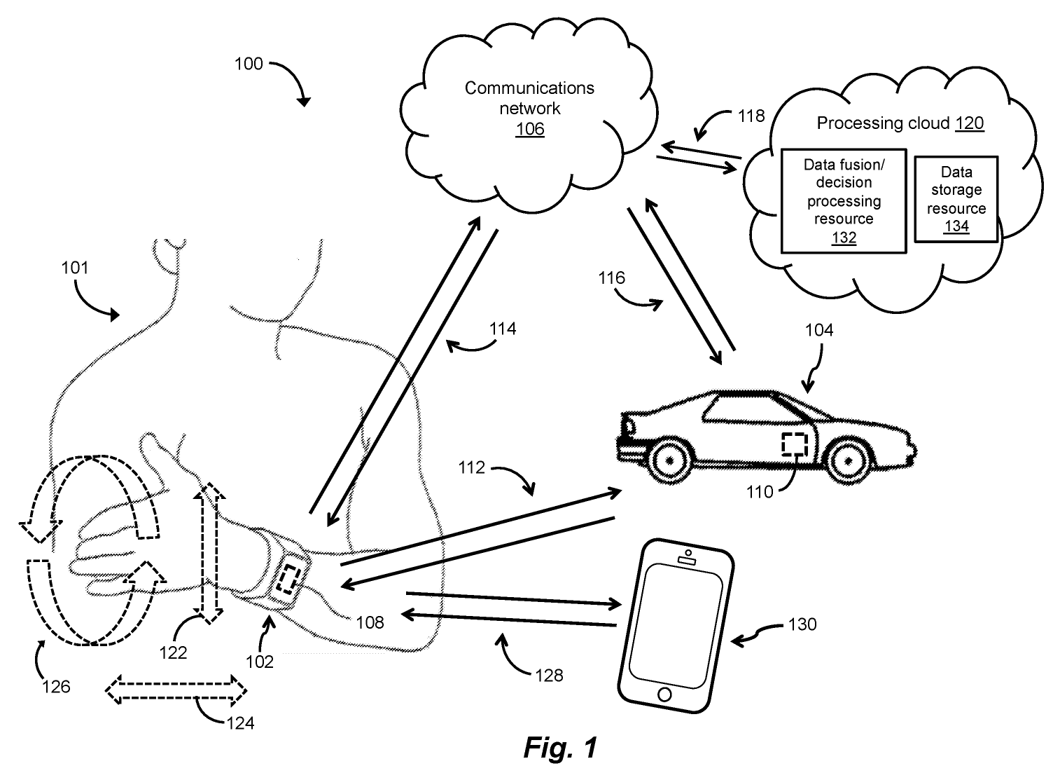

FIG. 1 depicts a typical environment 100, in which an illustrative embodiment of an exemplary wireless keyless entry system 108 for an automotive vehicle 104 may be employed, in accordance with the present application. As shown in FIG. 1, the wireless keyless entry system 108 is configured to be worn within a wearable key fob 102 on a wrist of an automotive operator 101. In an alternative embodiment, the wireless keyless entry system 108 can have a configuration that allows it to be worn within an armband, a headband, a chest band, a bracelet, a necklace, a device attachable to an article of clothing, or any other suitable wearable configuration. In the typical environment 100, the wireless keyless entry system 108 is operative to engage in bidirectional communications with telematics 110 included in the automotive vehicle 104 over wireless communication paths 112, a smartphone 130 over wired or wireless communication paths 128, as well as with a communications network 106 over wireless communication paths 114. In an alternative embodiment, the functionality of the smartphone 130 can be implemented by a tablet computer, a laptop computer, a desktop computer, or any other suitable computer or computerized device. The telematics 110 within the automotive vehicle 104 are likewise operative to engage in bidirectional communications with the communications network 106 over wireless communication paths 116. The wireless keyless entry system 108, the vehicle telematics 110, and the smartphone 130 are each further operative to engage in bidirectional communications via the communications network 106 with at least one processing cloud 120, which can include resources for performing data fusion/decision processing 132 and data storage 134, as well as for performing data analysis, data trending, data reduction, data encryption, etc.

As employed herein, the term “processing cloud” refers to one or more computers (e.g., servers and/or clients), computerized devices, and/or data storage devices that are accessible over one or more communications networks from one or more remote locations. Such computers and/or computerized devices within the processing cloud can include one or more processing units for performing data fusion/decision processing (referred to herein collectively as the “data fusion/decision processing resource”), and one or more data storage devices (referred to herein collectively as the “data storage resource”). Within the typical environment 100, the processing cloud 120 is configured to provide suitable hardware and/or software for implementing the data fusion/decision processing resource 132 and the data storage resource 134 (as well as for implementing data analysis, data trending, data reduction, and/or data encryption resources, etc.), and for providing access to the various data resources over the communications network 106 through secure data connections.

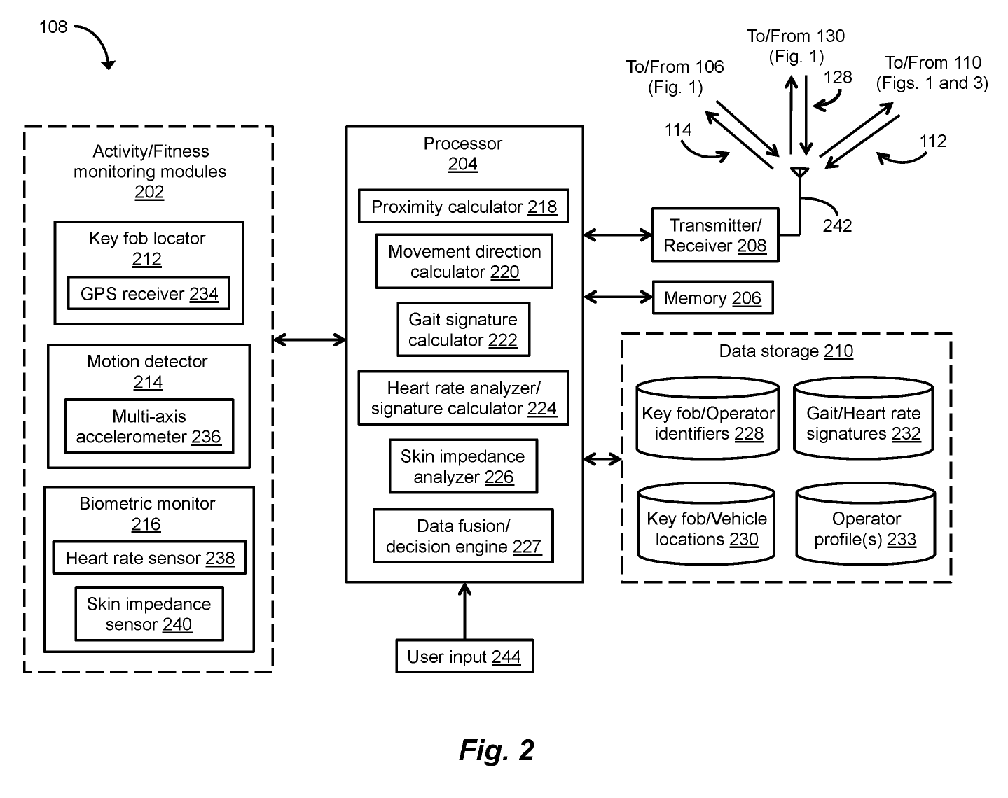

FIG. 2 depicts a detailed view of the wireless keyless entry system 108 of FIG. 1. As shown in FIG. 2, the wireless keyless entry system 108 has a plurality of operational modules, including a plurality of activity/fitness monitoring modules 202, a processor 204 and its associated memory 206, a data storage 210, a transmitter/receiver 208, and a mechanism for user input 244, which can be implemented by the smartphone 130, a tablet computer, a laptop computer, a desktop computer, or any other suitable user input mechanism. In one embodiment, the plurality of activity/fitness monitoring modules 202 can include, but are not limited to, a key fob locator 212 with a global positioning system (GPS) receiver 234, a motion detector 214 with a multi-axis accelerometer 236, and a biometric monitor 216 with a heart rate sensor 238 and a skin impedance sensor 240. The processor 204 can include a plurality of processing modules including a proximity calculator 218, a movement direction calculator 220, a gait signature calculator 222, a heart rate analyzer/signature calculator 224, a skin impedance analyzer 226, and a data fusion/decision engine 227. The data storage 210 can include a plurality of data storage areas or databases for storing key fob/operator identifiers 228, key fob/vehicle locations 230, gait/heart rate signatures 232, and operator profile(s) 233. The transmitter/receiver 208 can include an antenna 242 operative to transmit and receive wireless signals (e.g., at 433 MHz and 125 kHz, respectively, or any other suitable frequencies) such as RF signals over the wireless communication paths 112 to/from the telematics 110 of the automotive vehicle 104, over the wireless communication paths 114 to/from the communications network 106 (e.g., the Internet), as well as over the wired or wireless communication paths 128 to/from the smartphone 130.

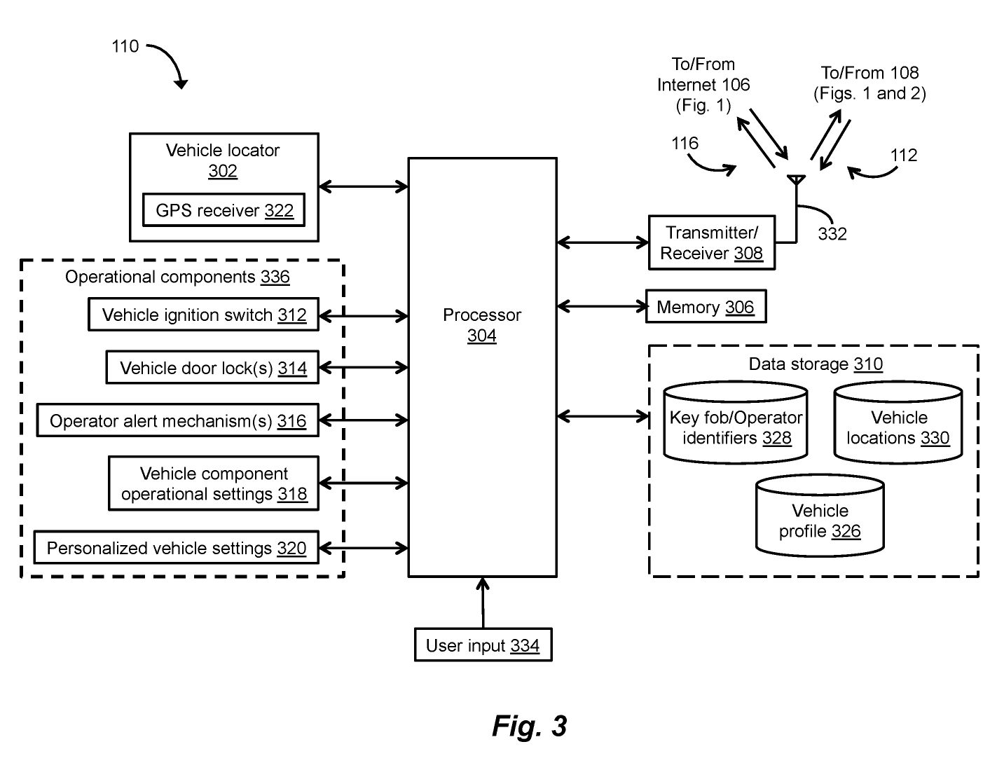

FIG. 3 depicts a detailed view of the telematics 110 included in the automotive vehicle 104 of FIG. 1. As shown in FIG. 3, the telematics 110 have a plurality of operational modules, including a vehicle locator 302 with a GPS receiver 322, a processor 304 and its associated memory 306, a data storage 310, a transmitter/receiver 308, and a mechanism for user input 334, which can be implemented by one or more dials, pushbuttons, sliders, touchscreens, etc., on a dashboard and/or console associated with the telematics 110 of the automotive vehicle 104, or any other suitable user input mechanism. The data storage 310 can include a plurality of data storage areas or databases for storing key fob/operator identifiers 328, vehicle locations 330, and a vehicle profile 326. The processor 304 can control functions of various operational components 336 of the automotive vehicle 104, including, but not limited to, a vehicle ignition switch 312, one or more vehicle door locks 314, one or more operator alert mechanisms 316 (e.g., audible alerts, visible alerts), vehicle component operational settings 318 (e.g., heating, ventilation, air conditioning (HVAC) settings), and personalized vehicle settings 320 (e.g., seat positions, steering wheel angles, entertainment content, mirror positioning, suspension settings). The data storage 310 can store data specifying the respective personalized vehicle settings 320 as part of the vehicle profile 326. The transmitter/receiver 308 can include an antenna 332 operative to transmit and receive wireless signals (e.g., at 125 kHz and 433 MHz, respectively, or any other suitable frequencies) such as RF signals over the wireless communication paths 116 to/from the communications network 106 (e.g., the Internet), as well as over the wireless communication paths 112 to/from the wireless keyless entry system 108.

The wireless keyless entry system 108 of FIGS. 1 and 2 is configured to employ activity, fitness, biometric, and/or location data for identifying the automotive operator 101 as an authorized operator of the automotive vehicle 104, determining a proximity of the wireless keyless entry system 108 to the automotive vehicle 104, determining a biometric state of the automotive operator 101, as well as for personalizing, tailoring, and/or controlling operational aspects of the automotive vehicle 104 based at least on such an authorized operator identification and/or such proximity/biometric state determinations.

The operation of the wireless keyless entry system 108 will be further understood with reference to the following illustrative example, as well as FIGS. 1-3. In this illustrative example, the automotive operator 101 (also referred to in this illustrative example as “Sophia”) (see FIG. 1) straps the wearable key fob 102 onto her wrist, and prepares to drive the automotive vehicle 104 from home to her place of business. As the automotive operator 101 approaches the automotive vehicle 104, the wireless keyless entry system 108 (see FIGS. 1 and 2) within the wearable key fob 102 gathers operator motion data (e.g., gait motion data) and/or operator biometric data (e.g., heart rate data, heart rate variability data, skin impedance data) from the automotive operator 101, calculates a gait signature and/or a heart rate signature using the gait motion data and/or the heart rate data, respectively, identifies the automotive operator 101 as an authorized operator of the automotive vehicle 104 based on the calculated gait/heart rate signature(s), and obtains an authorized operator identifier (also referred to herein as the “operator ID”) of the automotive operator 101 from the key fob/operator identifiers 228 within the data storage 210. For example, such an operator ID can be specified by the automotive operator 101 via the user input 244 (or automatically generated at least in part by the wireless keyless entry system 108), and further stored within the data storage 210 as part of the operator profile(s) 233. The wireless keyless entry system 108 determines the biometric state (e.g., stressed, angry, fatigued, relaxed, calm, energetic) of the automotive operator 101 based on the biometric data (e.g., heart rate data, heart rate variability data, skin impedance data) gathered from the automotive operator 101. During the automotive operator's approach to the automotive vehicle 104, the wireless keyless entry system 108 also gathers operator location data specifying one or more geographical locations of the wearable key fob 102 (which is strapped onto the wrist of the automotive operator 101).

In this illustrative example, some or all of the operator motion data (e.g., the gait motion data), the gait signature, the operator biometric data (e.g., heart rate data, heart rate variability data, skin impedance data), the heart rate signature, the operator biometric state data, the operator ID, and the operator location data gathered by the wireless keyless entry system 108 can be stored within the data storage 210 as at least one dataset of the operator profile(s) 233 for the automotive operator 101 (i.e., Sophia), as follows:

TABLE I
OPERATOR (Sophia) PROFILE

Operator (Sophia) ID
Operator (Sophia) location data
Operator (Sophia) biometric data

Cardiac data

Heart rate data

Heart rate signature

Heart rate variability data

Skin impedance data

Operator (Sophia) biometric state data (based on cardiac and/or skin
impedance data)

Stressed, angry, fatigued, relaxed, calm, or energetic

Operator (Sophia) motion data

Gait motion data

Gait signature

It is noted that the wireless keyless entry system 108 can store the operator profile(s) 233 of the automotive operator 101 (see, for example, TABLE I) within the data storage resource 134 of the processing cloud 120, as well as within the data storage 210 of the wireless keyless entry system 108.

With further regard to this illustrative example, location data for the automotive vehicle 104, one or more operator ID(s), and one or more operator personalized vehicle settings for at least one automotive operator (including the automotive operator 101, e.g., Sophia) can be stored within the data storage 310 of the vehicle telematics 110 as a dataset of the vehicle profile 326 for the automotive vehicle 104, as follows:

TABLE II
VEHICLE PROFILE

Vehicle location data
Operator ID(s) (Sophia, Jackson)

Operator (Sophia) ID

Operator (Sophia) personalized vehicle settings

Seat adjustment
Steering wheel angle
Entertainment content (based at least on biometric state
data)

Radio station setting(s)
Artist/album/playlist selection(s)

Mirror adjustment
Suspension setting (based at least on biometric state data)

Touring suspension setting
Sport suspension setting

Operator (Jackson) ID

Operator (Jackson) personalized vehicle settings

Seat adjustment
Steering wheel angle
Entertainment content (based at least on biometric state
data)

Radio station setting(s)
Artist/album/playlist selection(s)

Mirror adjustment
Suspension setting (based at least on biometric state data)

Touring suspension setting
Sport suspension setting

It is noted that, like the operator profile(s) 233 for the automotive operator 101, the vehicle profile 326 for the automotive vehicle 104 (see, for example, TABLE II) can also be stored within the data storage resource 134 of the processing cloud 120. It is further noted that the vehicle profile 326 for the automotive vehicle 104 (see, for example, TABLE II) contains operator IDs and operator data corresponding to more than one possible authorized operator (e.g., Sophia, Jackson) of the automotive vehicle 104.

Having gathered the operator location data specifying one or more geographical locations of the automotive operator 101, the wireless keyless entry system 108 accesses the vehicle location data specifying the geographical location of the automotive vehicle 104. To that end, the wireless keyless entry system 108 activates the transmitter/receiver 208 for communicating (e.g., over the communications network 106) with the processing cloud 120, from which the wireless keyless entry system 108 accesses the vehicle location data from the data storage resource 134. As employed herein, the phrase “activated for communicating with the processing cloud” refers to the transmitter/receiver 208 being activated to transmit/receive, to/from the processing cloud 120, wireless signals that may contain one or more operator IDs of one or more possible authorized operators of the automotive vehicle 104, but do not contain a key fob identifier (also referred to herein as the “key fob ID”) for the wearable key fob 102.

Using the operator location data and the vehicle location data, the wireless keyless entry system 108 determines the approximate geographical location of the automotive operator 101 (e.g., Sophia) relative to the geographical location of the automotive vehicle 104. Further, the wireless keyless entry system 108 activates the transmitter/receiver 208 for communicating with the vehicle telematics 110 when the automotive operator 101 becomes near (e.g., within a few meters of) the automotive vehicle 104. As employed herein, the phrase “activated for communicating with the vehicle telematics” refers to the transmitter/receiver 208 being activated to transmit/receive, to/from the vehicle telematics 110, wireless signals that may contain one or more operator IDs of one or more possible authorized operators of the automotive vehicle 104, as well as the key fob ID of the wearable key fob 102. For example, once the transmitter/receiver 208 is activated for communicating with the vehicle telematics 110, the automotive operator 101 may unlock the vehicle door lock(s) 314 of the automotive vehicle 104 by manually actuating a pushbutton included in the wearable key fob 102, causing the transmitter/receiver 208 to transmit a wireless signal (e.g., at 433 MHz or any other suitable frequency) containing at least the key fob ID to the vehicle telematics 110 for unlocking the vehicle door lock(s) 314. Upon receiving the wireless signal from the wearable key fob 102, the vehicle telematics 110 may transmit an encrypted challenge signal (e.g., at 125 kHz or any other suitable frequency) to the wireless keyless entry system 108, requiring the transmitter/receiver 208 to transmit a proper response signal to effectuate the unlocking of the vehicle door lock(s) 314. Alternatively, the wireless keyless entry system 108 may be configured to operate passively with the vehicle telematics 110 to automatically unlock the vehicle door lock(s) 314 of the automotive vehicle 104 once the transmitter/receiver 208 of the wireless keyless entry system 108 has been activated for communicating with the vehicle telematics 110.

Once the vehicle door lock(s) 314 of the automotive vehicle 104 are unlocked, the wireless keyless entry system 108 transmits, to the telematics 110 (see FIG. 3) of the automotive vehicle 104, at least one further wireless signal that contains at least the operator ID that corresponds to the authorized automotive operator 101 (e.g., Sophia), and data relating to the automotive operator's biometric state, such operator ID and operator biometric state data being obtained from the operator profile(s) 233 (see, for example, TABLE I). Having received the operator ID and the operator biometric state data contained in the wireless signal, the vehicle telematics 110 accesses and implements one or more initial (or default) personalized vehicle settings (e.g., the driver's seat position, the steering wheel angle, particular entertainment content, a rearview mirror positioning, the suspension setting, etc.), which were previously specified by the automotive operator 101 via the user input 334 and stored within the data storage 310 as part of the vehicle profile 326 (see, for example, TABLE II). Further, having received the data relating to the automotive operator's biometric state contained in the wireless signal, the vehicle telematics 110 adjusts one or more of the initial personalized vehicle settings to suit the automotive operator's current biometric state (e.g., stressed, angry, fatigued, relaxed, calm, energetic). For example, if the automotive operator's biometric state is determined to be energetic, then the vehicle telematics 110 may adjust the entertainment content (e.g., a radio station setting, an artist/album/playlist selection) to play upbeat music, and further adjust the suspension setting of the automotive vehicle 104 to a sport suspension setting. The automotive operator 101 then enters the automotive vehicle 104, fastens her seatbelt, and drives from home to her place of business.

Upon arriving at her place of business, the automotive operator 101 (e.g., Sophia) parks and exits the automotive vehicle 104. As the automotive operator 101 departs from the automotive vehicle 104, the wireless keyless entry system 108 within the wearable key fob 102 again gathers operator location data specifying one or more the geographical locations of the automotive operator 101 (wearing the wearable key fob 102), accesses updated vehicle location data specifying the geographical location of the parked automotive vehicle 104, and determines the automotive operator's current location relative to the location of the automotive vehicle 104. It is noted that such newly gathered operator location data and updated vehicle location data can be stored as part of the operator profile(s) 233 and the vehicle profile 326, respectively. Once it has been determined that the automotive operator 104 is departing from the automotive vehicle 104 based on the newly gathered operator location data and the updated vehicle location data, the wireless keyless entry system 108 operates in conjunction with the vehicle telematics 110 to automatically lock the vehicle door lock(s) 314 of the automotive vehicle 104. Further, the wireless keyless entry system 108 places the transmitter/receiver 208 in a non-transmitting state, preventing the key fob ID (as well as any operator ID(s)) from being inadvertently transmitted from the wearable key fob 102 and possibly captured by nefarious individuals for subsequent use in obtaining unauthorized access to the automotive vehicle 104.

At the end of the business day, the automotive operator 101 (e.g., Sophia) returns and approaches the automotive vehicle 104 at its parked location. Further, the wireless keyless entry system 108 within the wearable key fob 102 gathers operator motion data (e.g., gait motion data) and/or operator biometric data (e.g., heart rate data, heart rate variability data, skin impedance data) from the automotive operator 101, calculates a gait signature and/or a heart rate signature using the gait motion data and/or the heart rate data, respectively, identifies the automotive operator 101 as an authorized operator of the automotive vehicle 104 based on the calculated gait/heart rate signature(s), obtains the operator ID for the automotive operator 101, and determines the automotive operator's biometric state (e.g., stressed, angry, fatigued, relaxed, calm, energetic) based on the gathered biometric data. The wireless keyless entry system 108 also gathers location data specifying the geographical location(s) of the automotive operator 101 (wearing the wearable key fob 102), accesses the updated vehicle location data, and, using the operator location data and the vehicle location data, determines the automotive operator's current location relative to the parked location of the automotive vehicle 104. When the automotive operator 101 becomes near (e.g., within a few meters of) the parked location of the automotive vehicle 104, the wireless keyless entry system 108 transitions the transmitter/receiver 208 from the non-transmitting state to a transmitting/receiving state, thereby activating the transmitter/receiver 208 for communicating with the vehicle telematics 110 and allowing the vehicle door lock(s) 314 of the automotive vehicle 104 to be unlocked, either automatically or by the automotive operator's activation of the pushbutton included in the wearable key fob 102.

Once the vehicle door lock(s) 314 of the automotive vehicle 104 are unlocked, the wireless keyless entry system 108 transmits, to the telematics 110 of the automotive vehicle 104, at least one wireless signal that contains the operator ID of the authorized automotive operator 101 (e.g., Sophia), as well as the data relating to the automotive operator's current biometric state. Having received the operator ID and the operator biometric state data contained in the wireless signal, the vehicle telematics 110 accesses and implements, as needed, the initial personalized vehicle settings (e.g., the driver's seat position, the steering wheel angle, the particular entertainment content, the rearview mirror positioning, the suspension setting, etc.) of the automotive operator 101. Further, having received the data relating to the automotive operator's biometric state contained in the wireless signal, the vehicle telematics 110 adjusts one or more of the initial personalized vehicle settings to suit the automotive operator's current biometric state (e.g., stressed, angry, fatigued, relaxed, calm, energetic). For example, if the automotive operator's biometric state at the end of the business day is stressed, then the vehicle telematics 110 may adjust the entertainment content (e.g., the radio station setting, the artist/album/playlist selection) to play soothing music, and further adjust the suspension setting of the automotive vehicle 104 from the sport suspension setting to a softer touring suspension setting. The vehicle telematics 110 may also monitor the cabin temperature of the automotive vehicle 104, and, if the cabin temperature is found to be uncomfortably high, manipulate the automotive vehicle's air conditioning setting to bring the cabin temperature down to a more comfortable level. The automotive operator 101 then enters the automotive vehicle 104, fastens her seatbelt, and drives from her place of business to meet with friends.

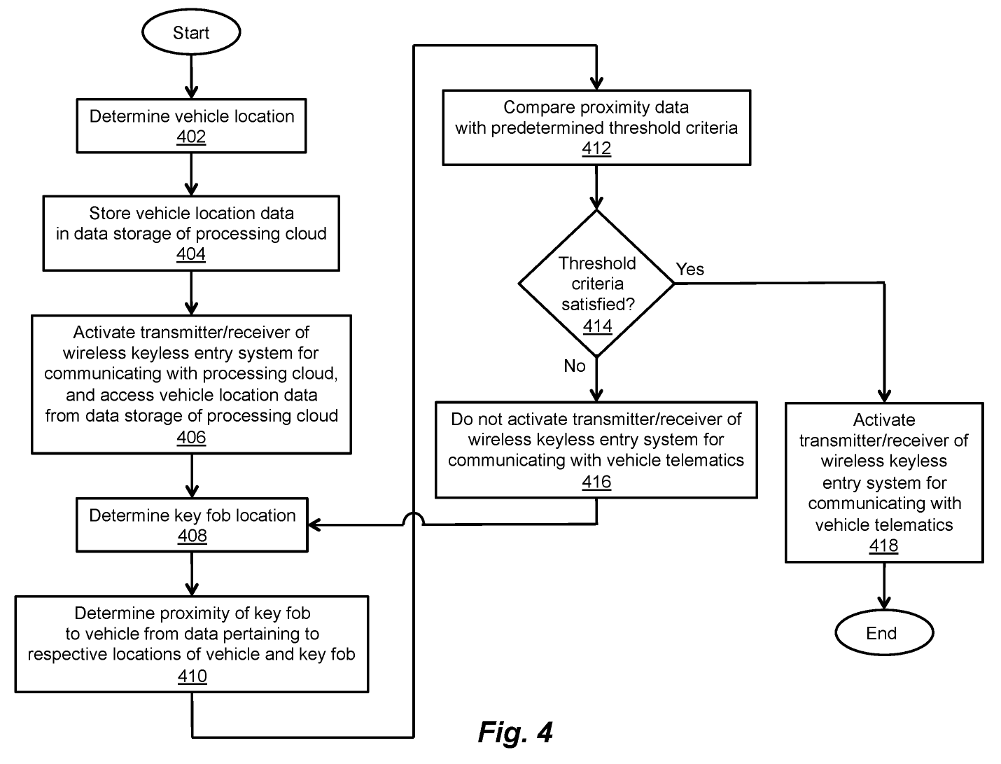

An exemplary method of operating the transmitter/receiver 208 within the wireless keyless entry system 108 based on the proximity of the wearable key fob 102 to the automotive vehicle 104 is described herein with reference to FIG. 4, as well as FIGS. 1-3. As depicted in block 402 (see FIG. 4), a geographical location of the automotive vehicle 104 (see FIG. 1) is determined by the vehicle locator 302 (see FIG. 3) of the vehicle telematics 110, using the GPS receiver 322. As depicted in block 404, location data specifying the geographical location of the automotive vehicle 104 are provided by the vehicle locator 302 to the processor 304 of the vehicle telematics 110, for subsequent transmission by the transmitter/receiver 308 over the communications network 106 and storage in the data storage resource 134 of the processing cloud 120. Such location data for the automotive vehicle 104 can be further stored by the processor 304 within the vehicle locations 330 area of the data storage 310 of the vehicle telematics 110. As depicted in block 406, the transmitter/receiver 208 of the wireless keyless entry system 108 is activated for communicating with the processing cloud 120, and the location data for the automotive vehicle 104 are accessed from the data storage resource 134 of the processing cloud 120 by the processor 204 (see FIG. 2) of the wireless keyless entry system 108. As depicted in block 408, a geographical location of the wearable key fob 102 is determined by the key fob locator 212 of the wireless keyless entry system 108, using the GPS receiver 234. As depicted in block 410, location data specifying the geographical location of the wearable key fob 102 are provided by the key fob locator 212 to the proximity calculator 218 of the wireless keyless entry system 108, which determines a proximity of the wearable key fob 102 to the automotive vehicle 104 from the location data pertaining to the respective geographical locations of the wearable key fob 102 and the automotive vehicle 104.

As depicted in block 412, data pertaining to the proximity of the wearable key fob 102 to the automotive vehicle 104 are compared with predetermined threshold criteria by the processor 204 of the wireless keyless entry system 108. For example, such predetermined threshold criteria may specify a predetermined radius (e.g., a few meters) around the parked location of the automotive vehicle 104, a predetermined perimeter around the parked location of the automotive vehicle 104, or any other suitable threshold criteria. As depicted in block 414, a determination is made as to whether or not the predetermined threshold criteria are satisfied by the proximity data. For example, such proximity data may be deemed to satisfy the predetermined threshold criteria if the wearable key fob 102 is geographically located within the predetermined perimeter around the automotive vehicle 104 (i.e., the automotive operator 101 wearing the wearable key fob 102 appears to be near the automotive vehicle 104). Further, such proximity data may be deemed not to satisfy the predetermined threshold criteria if the wearable key fob 102 is geographically located outside the predetermined perimeter around the automotive vehicle 104 (i.e., the automotive operator 101 wearing the wearable key fob 102 appears to be distant from the automotive vehicle 104). As depicted in block 416, if the predetermined threshold criteria are not satisfied by the proximity data, then the transmitter/receiver 208 of the wireless keyless entry system 108 is not activated for communicating with the vehicle telematics 110. As depicted in block 418, if the predetermined threshold criteria are satisfied by the proximity data, then the transmitter/receiver 208 of the wireless keyless entry system 108 is activated for communicating with the vehicle telematics 110, thereby enabling the wireless keyless entry system 108 to wirelessly communicate with the telematics 110 of the automotive vehicle 104.

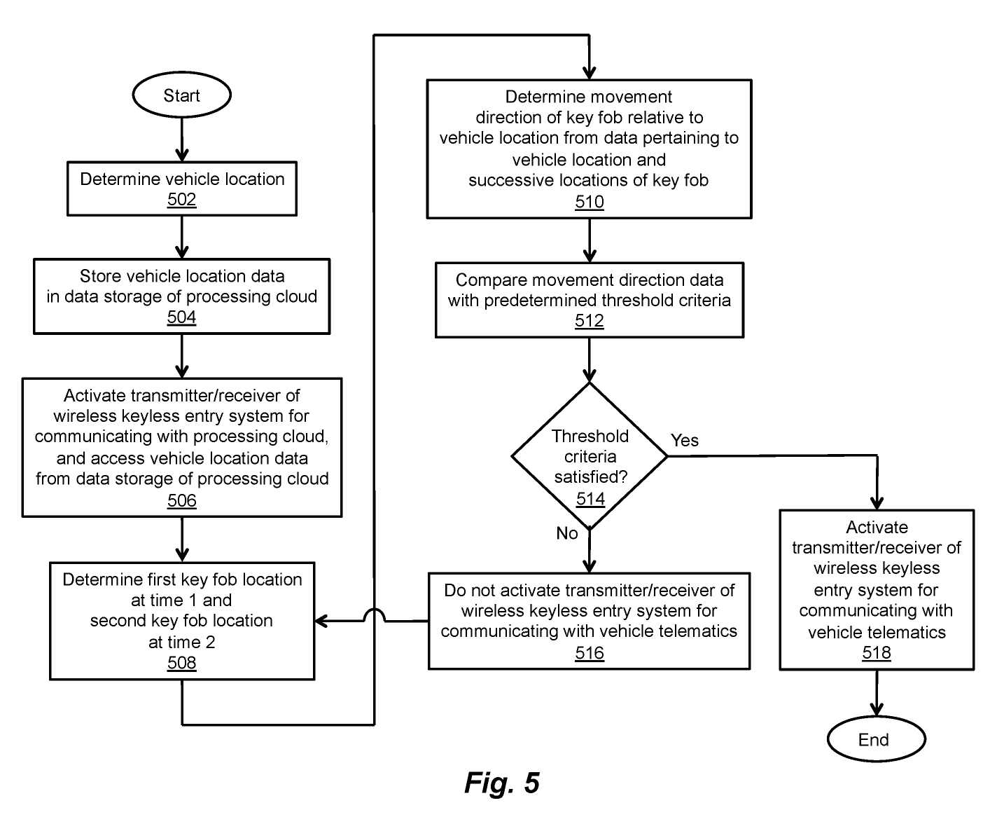

An exemplary method of operating the transmitter/receiver 208 within the wireless keyless entry system 108 based on a direction of movement of the wireless keyless entry system 108 relative to the automotive vehicle 104 is described herein with reference to FIG. 5, as well as FIGS. 1-3. It is noted that blocks 502, 504, and 506 of FIG. 5 are like blocks 402, 404, and 406 of FIG. 4, respectively, in which the geographical location of the automotive vehicle 104 is determined (see blocks 402 and 502), location data specifying the geographical location of the automotive vehicle 104 are stored in the data storage resource 134 of the processing cloud 120 (see blocks 404 and 504), and the location data for the automotive vehicle 104 are accessed from the data storage resource 134 of the processing cloud 120 (see blocks 406 and 506). As depicted in block 508 (see FIG. 5), a first geographical location of the wearable key fob 102 (see FIG. 1) at a first instance in time (“time 1”) and a second geographical location of the wearable key fob 102 at a successive second instance in time (“time 2”) are determined by the key fob locator 212 of the wireless keyless entry system 108, using the GPS receiver 234. For example, upon determination of the first and second geographical locations of the wearable key fob 102, the location data pertaining to the first geographical location and the second geographical location can be time-stamped by the key fob locator 212 with indications of time 1 and time 2, respectively. As depicted in block 510, location data specifying the geographical locations of the wearable key fob 102 at the respective times 1 and 2 are provided by the key fob locator 212 to the movement direction calculator 220 of the wireless keyless entry system 108, which determines a direction of movement of the wearable key fob 102 relative to the automotive vehicle 104 from the time-stamped location data pertaining to the first and second geographical locations of the wearable key fob 102, as well as the location data pertaining to the geographical location of the automotive vehicle 104.

As depicted in block 512, data pertaining to the direction of movement of the wearable key fob 102 relative to the automotive vehicle 104 are compared with predetermined threshold criteria by the processor 204 of the wireless keyless entry system 108. For example, such predetermined threshold criteria may specify a predetermined movement direction approaching (or departing from) the automotive vehicle 104, or any other suitable threshold criteria. As depicted in block 514, a determination is made as to whether or not the predetermined threshold criteria are satisfied by the movement direction data. For example, such movement direction data may be deemed to satisfy the predetermined threshold criteria if the wearable key fob 102 is geographically located closer to the parked location of the automotive vehicle 104 at time 2 than at time 1 (i.e., the automotive operator 101 wearing the wearable key fob 102 appears to be approaching the automotive vehicle 104). Further, such proximity data may be deemed not to satisfy the predetermined threshold criteria if the wearable key fob 102 is geographically located farther away from the parked location of the automotive vehicle 104 at time 2 than at time 1 (i.e., the automotive operator 101 wearing the wearable key fob 102 appears to be departing from the automotive vehicle 104). As depicted in block 516, if the predetermined threshold criteria are not satisfied by the movement direction data, then the transmitter/receiver 208 of the wireless keyless entry system 108 is not activated for communicating with the vehicle telematics 110. As depicted in block 518, if the predetermined threshold criteria are satisfied by the movement direction data, then the transmitter/receiver 208 of the wireless keyless entry system 108 is activated for communicating with the vehicle telematics 110, enabling the wireless keyless entry system 108 to wirelessly communicate with the telematics 110 (see FIG. 3) of the automotive vehicle 104.

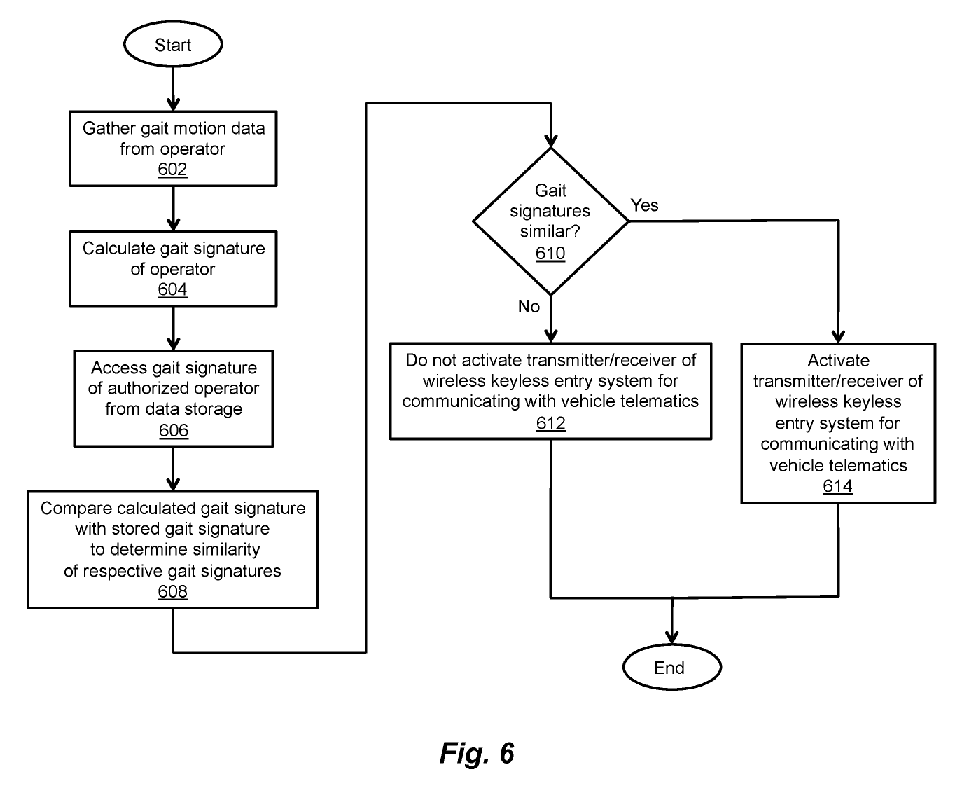

An exemplary method of operating the transmitter/receiver 208 within the wireless keyless entry system 108 based on a gait signature of the automotive operator 101 wearing the wearable key fob 102 is described herein with reference to FIG. 6, as well as FIGS. 1-3. As depicted in block 602 (see FIG. 6), gait motion data (e.g., acceleration data) are gathered, by the motion detector 214 (see FIG. 2) of the wireless keyless entry system 108, from the automotive operator 101 (see FIG. 1) using the multi-axis accelerometer 236. For example, such gait motion data may be gathered by the motion detector 214 for a predetermined number of steps (e.g., at least three steps) taken by the automotive operator 101, as well as over a predetermined time period (e.g., at least five seconds). As depicted in block 604, the gait motion data are provided by the motion detector 214 to the gait signature calculator 222 of the processor 204 for subsequent calculation of the gait signature of the automotive operator 101. For example, the gait signature may correspond to a dataset obtained from calculating the average acceleration data over the predetermined time period. Further, such a calculation of the gait signature may include fitting the gait motion data to a suitable curve or mathematical function to facilitate comparison of the calculated gait signature with one or more gait signatures of authorized vehicle operators, which may be stored in the gait/heart rate signatures 232 area of the data storage 210 of the wireless keyless entry system 108.

As depicted in block 606, the gait signature of such an authorized operator of the automotive vehicle 104 is accessed, by the processor 204, from the gait/heart rate signatures 232 area of the data storage 210. As depicted in block 608, the calculated gait signature is compared with the stored gait signature of the authorized operator to determine a degree of closeness or similarity in the respective gait signatures or datasets, thereby determining whether or not the automotive operator 101 is an authorized operator of the automotive vehicle 104. As depicted in block 610, a determination is made as to whether or not the respective gait signatures are deemed to be similar. As depicted in block 612, if the respective gait signatures are deemed not to be similar (i.e., the automotive operator 101 wearing the wearable key fob 102 appears not to be an authorized operator of the automotive vehicle 104), then the transmitter/receiver 208 of the wireless keyless entry system 108 is not activated for communicating with the vehicle telematics 110. As depicted in block 614, if the respective gait signatures are deemed to be similar (i.e., the automotive operator 101 wearing the wearable key fob 102 appears to be an authorized operator of the automotive vehicle 104), then the transmitter/receiver 208 of the wireless keyless entry system 108 is activated for communicating with the vehicle telematics 110, enabling the wireless keyless entry system 108 to wirelessly communicate with the telematics 110 (see FIG. 3) of the automotive vehicle 104.

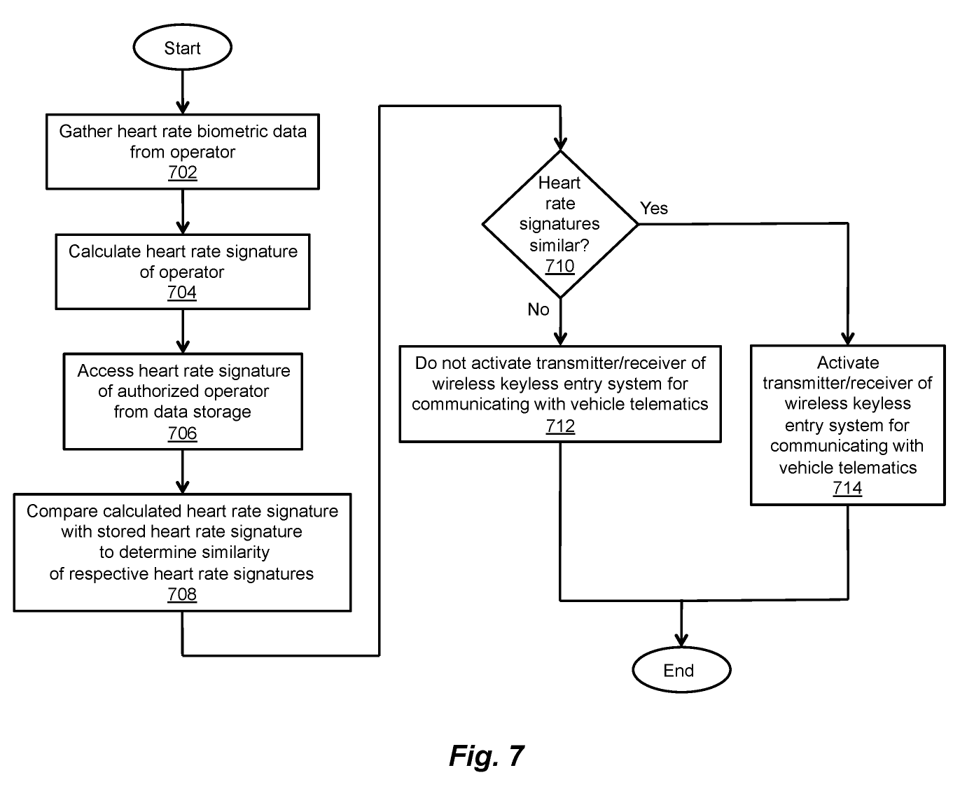

A further exemplary method of operating the transmitter/receiver 208 within the wireless keyless entry system 108 based on a heart rate signature of the automotive operator 101 wearing the wearable key fob 102 is described herein with reference to FIG. 7, as well as FIGS. 1-3. As depicted in block 702 (see FIG. 7), heart rate data are gathered, by the biometric monitor 216 (see FIG. 2) of the wireless keyless entry system 108, from the automotive operator 101 (see FIG. 1) using the heart rate sensor 238. For example, such heart rate data may be gathered by the biometric monitor 216 over a predetermined time period (e.g., at least one minute). As depicted in block 704, the heart rate data are provided by the biometric monitor 216 to the heart rate analyzer/signature calculator 224 of the processor 204 for subsequent calculation of the heart rate signature of the automotive operator 101. For example, the heart rate signature may correspond to a dataset obtained from calculating the average heart rate data over the predetermined time period. Further, as in the calculation of the automotive operator's gait signature, such a calculation of the automotive operator's heart rate signature may include fitting the wrist-based heart rate data to a suitable curve or mathematical function to facilitate comparison of the calculated heart rate signature with one or more heart rate signatures of authorized vehicle operators, which may be stored in the gait/heart rate signatures 232 area of the data storage 210 of the wireless keyless entry system 108.

As depicted in block 706, the heart rate signature of such an authorized operator of the automotive vehicle 104 is accessed, by the processor 204, from the gait/heart rate signatures 232 area of the data storage 210. As depicted in block 708, the calculated heart rate signature is compared with the stored heart rate signature of the authorized operator to determine a degree of closeness or similarity in the respective heart rate signatures or datasets, thereby determining whether or not the automotive operator 101 is an authorized operator of the automotive vehicle 104. As depicted in block 710, a determination is made as to whether or not the respective heart rate signatures are deemed to be similar. As depicted in block 712, if the respective heart rate signatures are deemed not to be similar (i.e., the automotive operator 101 wearing the wearable key fob 102 appears not to be an authorized operator of the automotive vehicle 104), then the transmitter/receiver 208 within the wireless keyless entry system 108 is not activated for communicating with the vehicle telematics 110. As depicted in block 714, if the respective heart rate signatures are deemed to be similar (i.e., the automotive operator 101 wearing the wearable key fob 102 appears to be an authorized operator of the automotive vehicle 104), then the transmitter/receiver 208 within the wireless keyless entry system 108 is activated for communicating with the vehicle telematics 110, enabling the wireless keyless entry system 108 to wirelessly communicate with the telematics 110 (see FIG. 3) of the automotive vehicle 104.

To enhance the security, safety, and/or convenience of the automotive operator 101, the wireless keyless entry system 108 within the wearable key fob 102 can perform data fusions on data stored in the operator profile(s) 233 (e.g., operator ID, operator location data, operator biometric data, operator biometric state data, operator motion data) and data stored in the vehicle profile 326 (e.g., vehicle location data, operator ID(s), operator personalized vehicle settings) in order to infer at least (1) that the automotive operator 101 is an authorized operator of the automotive vehicle 104, (2) that the automotive operator 101 is near, approaching, or departing from the automotive vehicle 104, (3) the automotive operator's biometric state, (4) a potential emergency condition or situation pertaining to the automotive operator 101, and/or (5) the automotive operator's consumer preferences and/or behavioral patterns.

To that end, the data fusion/decision engine 227 of the processor 204 can effectively fuse or combine the location data gathered by the key fob locator 212 and/or the vehicle locator 302, the motion data gathered by the motion detector 214, and/or the biometric data gathered by the biometric monitor 216 in accordance with certain decision criteria, and use the fused or combined data to make inferences about the automotive operator 101 in relation to the automotive vehicle 104. Moreover, the quality of the inferences made by the data fusion/decision engine 227 can be improved, as desired and/or required, based on the quality and/or the quantity of such location data, motion data, and/or biometric data used to make such inferences. For example, if the degree of closeness or similarity in respective calculated and stored signatures (e.g., gait signatures, heart rate signatures) is high, then the quality of an inference made by the data fusion/decision engine 227 is increased. Further, if the degree of closeness or similarity in respective calculated and stored signatures (e.g., gait signatures, heart rate signatures) is low, then the quality of the inference made by the data fusion/decision engine 227 is reduced.

In one embodiment, the resources included in the processing cloud 120 (see FIG. 1) for performing data fusion/decision processing 132 and data storage 134 can be used to effectively fuse or combine the dataset of the operator profile(s) 233 of the automotive operator 101 and the dataset of the vehicle profile 326 of the automotive vehicle 104. As noted herein, the operator profile(s) 233 of the automotive operator 101 and the vehicle profile 326 of the automotive vehicle 104 can be stored locally in the data storage 210 of the wireless keyless entry system 108 and in the data storage 310 of the vehicle telematics 110, respectively, as well as remotely in the data storage resource 134 of the processing cloud 120.

In this embodiment, the data fusion/decision processing resource 132 of the processing cloud 120 can access the exemplary datasets of the operator profile(s) 233 (see, for example, TABLE I—OPERATOR (Sophia) PROFILE) and the vehicle profile 326 (see, for example, TABLE II—VEHICLE PROFILE), and fuse or combine the datasets of the respective operator and vehicle profiles based at least on the operator ID (e.g., the operator ID of Sophia) to obtain a fused/combined profile of the automotive operator 101 and the automotive vehicle 104, as follows:

TABLE III
FUSED/COMBINED AUTOMOTIVE
OPERATOR/VEHICLE PROFILE

Vehicle location data
Operator (Sophia) location data
Operator ID (Sophia)

Operator (Sophia) personalized vehicle settings

Seat adjustment
Steering wheel angle
Entertainment content (based at least on biometric state; e.g.,
energetic, stressed, etc.)

Radio station setting(s)

WZLX-FM - Classic Rock (biometric state =
energetic)
WCRB-FM - Classical Radio (biometric state =
stressed)

Artist/album/playlist selection(s)

Green Day (biometric state = energetic)
Wolfgang Mozart (biometric state = stressed)

Mirror adjustment
Suspension setting (based at least on biometric state; e.g.,
energetic, stressed, etc.)

Sport suspension setting (biometric state = energetic)
Touring suspension setting (biometric state = stressed)

It is noted that the fused/combined profile of the automotive operator 101 and the automotive vehicle 104 (see, for example, TABLE III) can be stored in the data storage 210 of the wireless keyless entry system 108, the data storage 310 of the vehicle telematics 110, and/or the data storage resource 134 of the processing cloud 120. It is further noted that the exemplary dataset of the fused/combined profile provided in TABLE III (FUSED/COMBINED AUTOMOTIVE OPERATOR/VEHICLE PROFILE) contains data for the automotive operator named Sophia, only. It will be appreciated that the fusion or combination of a dataset of an operator profile of the automotive operator named Jackson (not shown) and the dataset of the vehicle profile 326 of the automotive vehicle 104 (see, e.g., TABLE II—VEHICLE PROFILE) can result in a fused/combined automotive operator/vehicle profile that contains data for the automotive operator named Jackson, only.

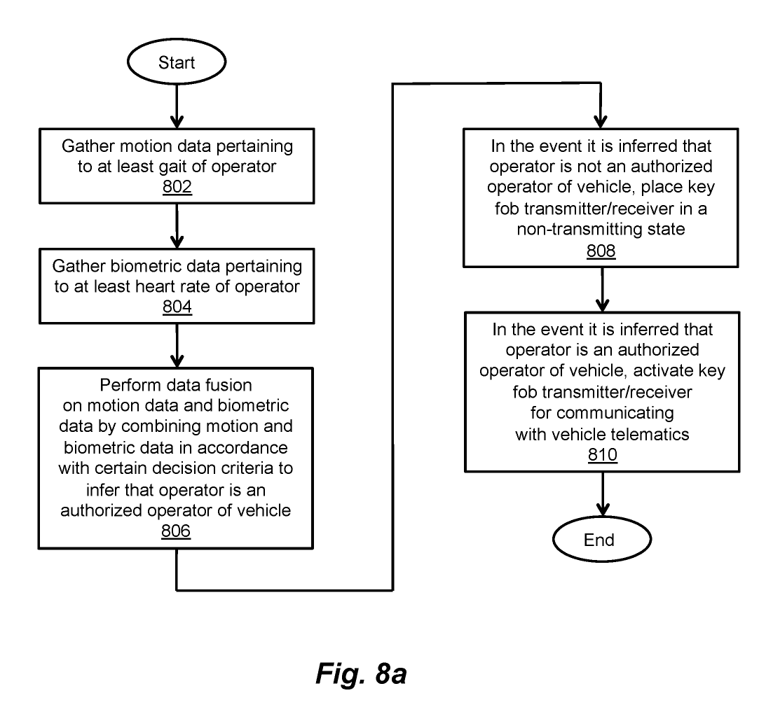

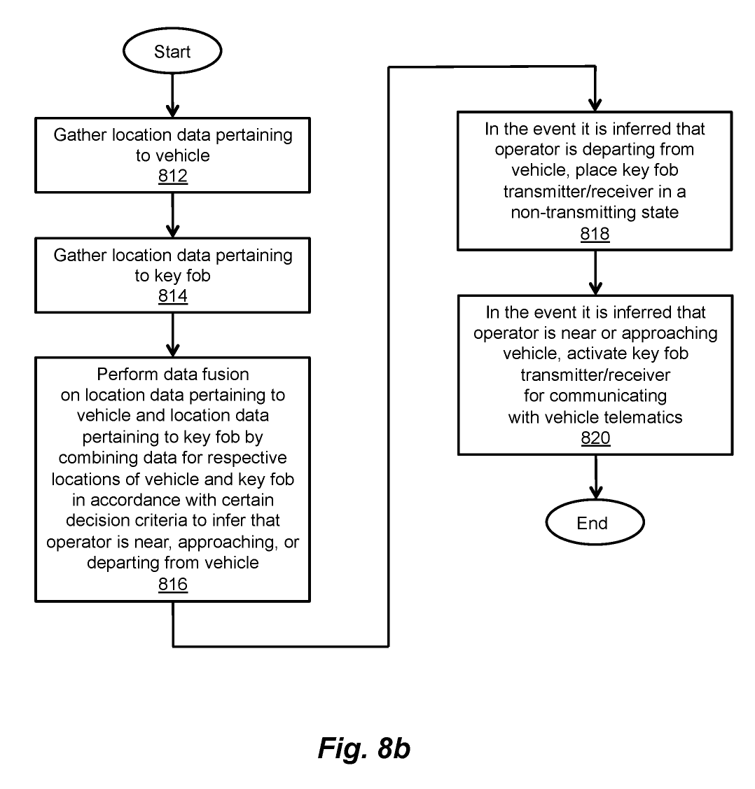

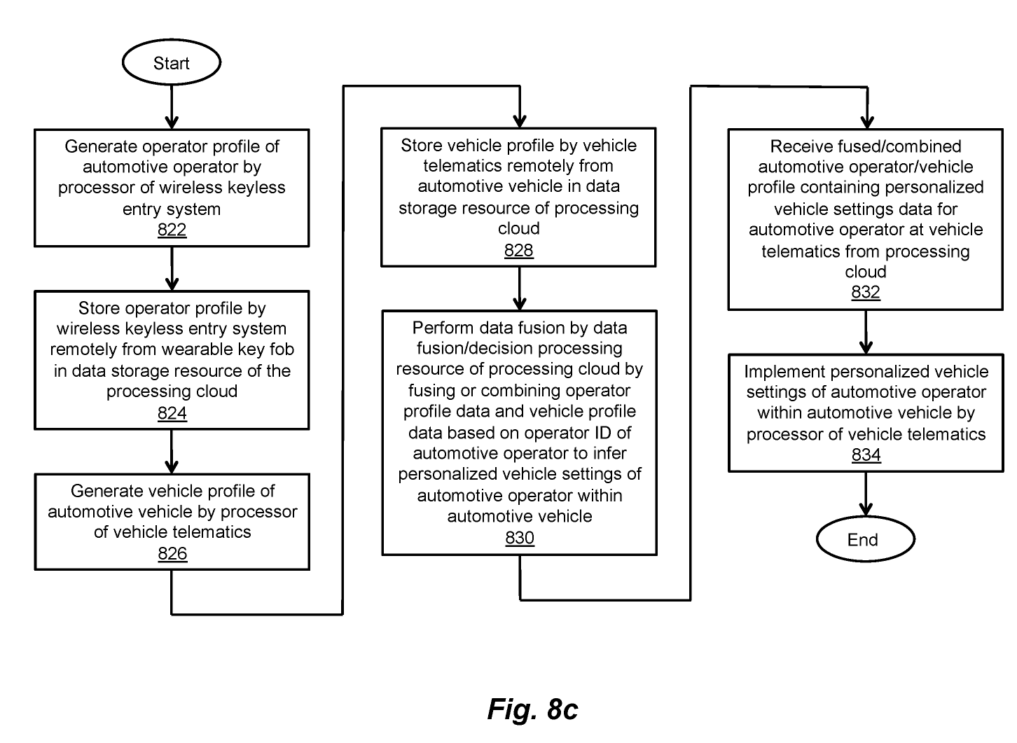

An exemplary method of performing data fusion on gait motion data and heart rate biometric data gathered from the automotive operator 101 wearing the wearable key fob 102, in order to infer that the automotive operator 101 is an authorized operator of the automotive vehicle 104, is described herein with reference to FIG. 8a, as well as FIGS. 1-3. As depicted in block 802 (see FIG. 8a), operator motion data are gathered pertaining to at least the gait of the automotive operator 101 (see FIG. 1) by the motion detector 214 (see FIG. 2) of the wireless keyless entry system 108. As depicted in block 804, operator biometric data are gathered pertaining to at least the heart rate of the automotive operator 101 by the biometric monitor 216 of the wireless keyless entry system 108. As depicted in block 806, a data fusion is performed, by the data fusion/decision engine 227 of the wireless keyless entry system 108, by fusing or combining the gait motion data and the heart rate biometric data gathered from the automotive operator 101 to infer whether or not the automotive operator 101 is an authorized operator of the automotive vehicle 104. For example, such an inference about the automotive operator 101 may be made in response to fusing or combining the gait motion data and the heart rate biometric data from the automotive operator 101 in accordance with certain decision criteria, taking into account gait motion data, heart rate biometric data, gait signatures, and/or heart rate signatures previously obtained from the automotive operator 101, as well as from one or more other possible authorized operators of the automotive vehicle 104. As depicted in block 808, in the event it is inferred that the automotive operator 101 is not an authorized operator of the automotive vehicle 104, the transmitter/receiver 208 within the wireless keyless entry system 108 is placed in a non-transmitting state. As depicted in block 810, in the event it is inferred that the automotive operator 101 is an authorized operator of the automotive vehicle 104, the transmitter/receiver 208 within the wireless keyless entry system 108 is activated for communicating with the vehicle telematics 110, enabling the wireless keyless entry system 108 to wirelessly communicate with the telematics 110 (see FIG. 3) of the automotive vehicle 104.

An exemplary method of performing data fusion on location data pertaining to the wireless keyless entry system 108 and location data pertaining to the automotive vehicle 104, in order to infer that the automotive operator 101 wearing the wearable key fob 102 is near, approaching, or departing from the automotive vehicle 104, is described herein with reference to FIG. 8b, as well as FIGS. 1-3. As depicted in block 812 (see FIG. 8b), location data specifying the geographical location of the automotive vehicle 104 (see FIG. 1) are gathered, by the vehicle locator 302 (see FIG. 3) of the vehicle telematics 110, using the GPS receiver 322. As depicted in block 814, location data specifying one or more geographical locations of the wearable key fob 102 are gathered, by the key fob locator 212 (see FIG. 2) of the wireless keyless entry system 108, using the GPS receiver 234. As depicted in block 816, a data fusion is performed, by the data fusion/decision engine 227 of the wireless keyless entry system 108, by fusing or combining the location data for the automotive vehicle 104 and the location data for the wearable key fob 102 to infer that the automotive operator 101 is near, approaching, or departing from the automotive vehicle 104. For example, such an inference about the automotive operator 101 may be made in response to fusing or combining the location data for each of the automotive vehicle 104 and the wearable key fob 102 in accordance with certain decision criteria, taking into account a particular venue (e.g., the automotive operator's home or work, a parking garage, a city street) where the automotive vehicle 104 and/or the automotive operator 101 wearing the wearable key fob 102 are currently geographically located. As depicted in block 818, in the event it is inferred that the automotive operator 101 is departing from the automotive vehicle 104, the transmitter/receiver 208 within the wireless keyless entry system 108 is placed in a non-transmitting state. As depicted in block 820, in the event it is inferred that the automotive operator 101 is near or approaching the automotive vehicle 104, the transmitter/receiver 208 within the wireless keyless entry system 108 is activated for communicating with the vehicle telematics 110, enabling the wireless keyless entry system 108 to wirelessly communicate with the telematics 110 of the automotive vehicle 104. For example, if the particular venue where the automotive vehicle 104 and/or the automotive operator 101 are currently geographically located is a parking garage or a city street, then the decision criteria employed in the data fusion may dictate that the transmitter/receiver 208 of the wireless keyless entry system 108 be activated in block 818 (see FIG. 8b) at a closer distance (e.g., from 1 to 2 meters) between the location of the wearable key fob 102 and the location of the automotive vehicle 104 for security reasons.

An exemplary method of performing data fusion on an operator profile of the automotive operator 101 wearing the wearable key fob 102 and a vehicle profile of the automotive vehicle 104, in order to infer and implement personalized vehicle settings within the automotive vehicle 104, is described herein with reference to FIG. 8c, as well as FIGS. 1-3. As depicted in block 822 (see FIG. 8c), the operator profile of the automotive operator 101 is generated by the processor 204 of the wireless keyless entry system 108. For example, the operator profile may include an operator ID, operator location data, operator biometric data (e.g., heart rate data, heart rate variability data, skin impedance data), operator biometric state data (e.g., stressed, angry, fatigued, relaxed, calm, energetic), and operator motion data (e.g., gait motion data). As depicted in block 824, the operator profile is stored by the wireless keyless entry system 108 remotely from the wearable key fob 102 in the data storage resource 134 of the processing cloud 120. As depicted in block 826, the vehicle profile of the automotive vehicle 104 is generated by the processor 304 of the vehicle telematics 110. For example, the vehicle profile may include vehicle location data, one or more operator IDs, and personalized vehicle settings (e.g., driver's seat position, steering wheel angle, entertainment content, mirror positioning, suspension setting) corresponding to the respective operator IDs. As depicted in block 828, the vehicle profile is stored by the vehicle telematics 110 remotely from the automotive vehicle 104 in the data storage resource 134 of the processing cloud 120. As depicted in block 830, a data fusion is performed, by the data fusion/decision processing resource 132 of the processing cloud 120, by fusing or combining the operator profile data and the vehicle profile data based on the operator ID of the automotive operator 101 to infer the personalized vehicle settings 320 of the automotive operator 101 within the automotive vehicle 104. For example, such an inference about the personalized vehicle settings 320 of the automotive operator 101 may be made in response to fusing or combining the operator profile data and the vehicle profile data based on the operator ID to obtain a fused/combined automotive operator/vehicle profile that contains data pertaining to the personalized vehicle settings of the automotive operator 101, only. As depicted in block 832, the fused/combined automotive operator/vehicle profile containing the personalized vehicle settings data for the automotive operator 101 is received at the vehicle telematics 110 from the processing cloud 120. As depicted in block 834, the personalized vehicle settings 320 of the automotive operator 101 are implemented within the automotive vehicle 104 by the processor 304 of the vehicle telematics 110. For example, such personalized vehicle settings 320 of the automotive operator 101 may be implemented to provide a seat position, a steering wheel angle, particular entertainment content, a mirror positioning, and/or a suspension setting that were previously selected and/or inputted by the automotive operator 101 into the vehicle telematics 110 via the user input 334.

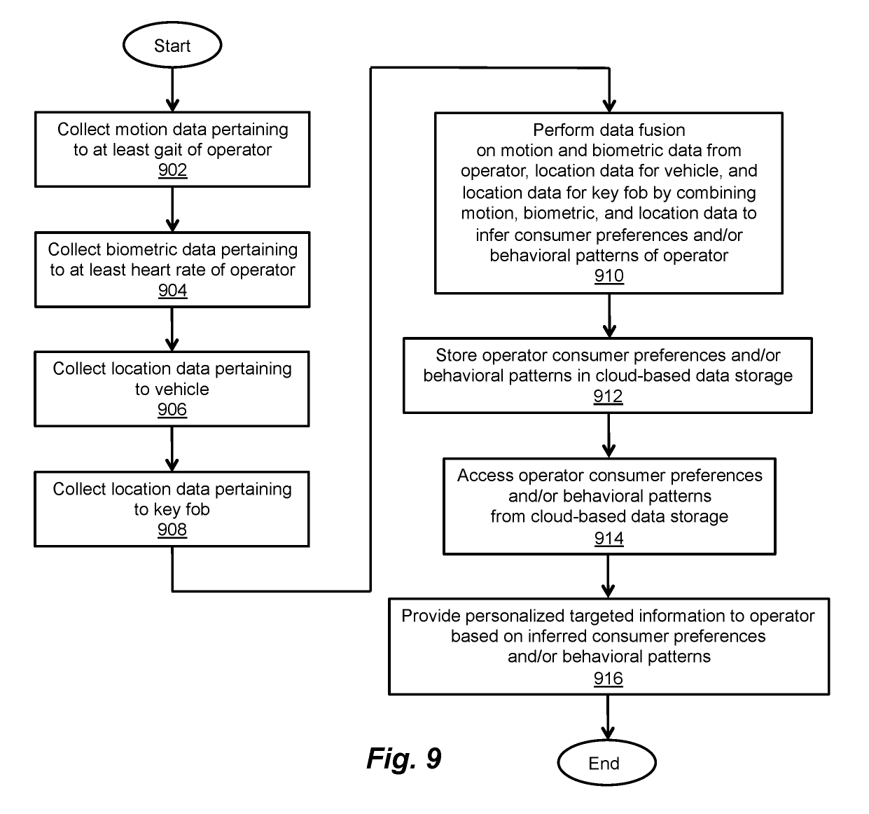

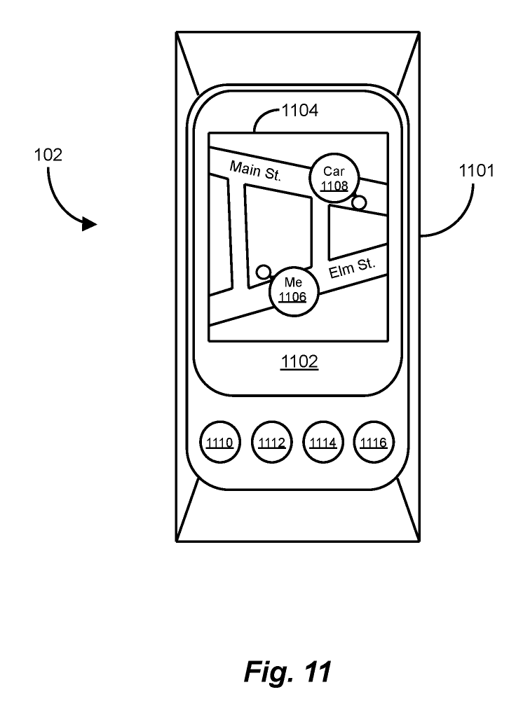

An exemplary method of performing data fusion on motion data and/or biometric data pertaining to the automotive operator 101 wearing the wearable key fob 102, location data pertaining to the wireless keyless entry system 108, and/or location data pertaining to the automotive vehicle 104, in order to infer consumer preferences and/or behavioral patterns of the automotive operator 101, is described herein with reference to FIG. 9, as well as FIGS. 1-3. In the exemplary method of FIG. 9, the automotive operator 101 can wear the wearable key fob 102 in substantially the same way as she would wear an activity tracker such as those sold by Garmin™, Fitbit™, Jawbone™, and others. Further, the wireless keyless entry system 108 within the wearable key fob 102 can gather the motion data and the biometric data from the automotive operator 101, the location data for the wireless keyless entry system 108, and the location data for the automotive vehicle 104, and perform a data fusion on the motion, biometric, and location data to infer the automotive operator's consumer preferences and/or behavioral patterns, which can subsequently be stored in the data storage resource 134 of the processing cloud 120. In this way, the cloud-based data storage resource 134 can provide a database of information pertaining to the automotive operator's consumer preferences and/or behavioral patterns, which a provider of the wearable key fob 102 (e.g., an automotive vehicle company or any other suitable third party entity) can access and use to provide personalized targeted advertisements and/or services to the automotive operator 101 via a display (e.g., a display 1102; see FIG. 11) of the wearable key fob 102 and/or through the vehicle telematics 110.

As depicted in block 902 (see FIG. 9), motion data are gathered, by the motion detector 214 (see FIG. 2) of the wireless keyless entry system 108, pertaining to at least the gait of the automotive operator 101 (see FIG. 1) using the multi-axis accelerometer 236. As depicted in block 904, biometric data are gathered, by the biometric monitor 216 of the wireless keyless entry system 108, pertaining to at least the heart rate of the automotive operator 101 using the heart rate sensor 238. As depicted in block 906, location data specifying the geographical location of the automotive vehicle 104 are gathered, by the vehicle locator 302 (see FIG. 3) of the vehicle telematics 110 using the GPS receiver 322, and provided by the vehicle telematics 110 to the processor 204 of the wireless keyless entry system 108. As depicted in block 908, location data specifying one or more geographical locations of the wearable key fob 102 are gathered, by the key fob locator 212 of the wireless keyless entry system 108, using the GPS receiver 234. As depicted in block 910, a data fusion is performed, by the data fusion/decision engine 227 of the wireless keyless entry system 108, by fusing or combining the gait motion data, the heart rate data, the location data pertaining to the automotive vehicle 104, and/or the location data pertaining to the wearable key fob 102 to infer the consumer preferences and/or the behavioral patterns of the automotive operator 101. For example, such inferences of the consumer preferences and/or behavioral patterns of the automotive operator 101 may be based on one or more of the automotive operator's activities, such as taking one or more trips to a certain coffee shop during the workweek, shopping at a certain shopping center on the weekend, going for a run along a certain route during off-work hours, etc. As depicted in block 912, information pertaining to the inferred consumer preferences and/or behavioral patterns of the automotive operator 101 is transmitted by the transmitter/receiver 208 of the wireless keyless entry system 108 over the communications network 106 for storage in the data storage resource 134 of the processing cloud 120. In one embodiment, such information pertaining to the automotive operator's consumer preferences and/or behavioral patterns can be accessed, by the automotive vehicle company (or any other suitable third party entity), from the cloud-based data storage resource 134, as depicted in block 914. As depicted in block 916, personalized targeted advertisements, services, or other information can subsequently be provided, by the automotive vehicle company or other third party entity, to the automotive operator 101 based on her inferred consumer preferences and/or behavioral patterns.

Such personalized targeted advertisements, services, and/or other information may be provided by the automotive vehicle company or other third party entity to the automotive operator 101 by transmitting such information for display on the wearable key fob 102, transmitting such information to the smartphone 130 linked to the wearable key fob 102, transmitting such information to the vehicle telematics 110, and/or by any other suitable manner of personalized targeted information transmission. For example, the consumer preferences and/or behavioral patterns accessed from the cloud-based data storage resource 134 may indicate that the automotive operator 101 frequently stops at Emma's Coffee Shop on her way to her place of business. Having accessed that information about the automotive operator 101 from the cloud-based data storage resource 134, the automotive vehicle company or other third party entity may transmit an electronic coupon for a muffin, a doughnut, or a breakfast sandwich available at Emma's Coffee Shop to the wearable key fob 102, the smartphone 130 linked to the wearable key fob 102, and/or the vehicle telematics 110. Alternatively (or in addition), the automotive vehicle company or other third party entity may direct the vehicle telematics 110 to audibly and/or visibly ask the automotive operator 101 whether or not she wishes to purchase her morning coffee from Emma's Coffee Shop on her way to her place of business. The automotive operator 101 may then provide a verbal response (e.g., “Yes!”) to the vehicle telematics 110, which may then automatically call-in her order to Emma's Coffee Shop so that her coffee order is ready as the automotive vehicle 104 approaches the coffee shop's drive-through window. Various other scenarios of providing personalized targeted advertisements, services, or other information to the automotive operator 101 based on her stored consumer preferences and/or behavioral patterns are also possible.

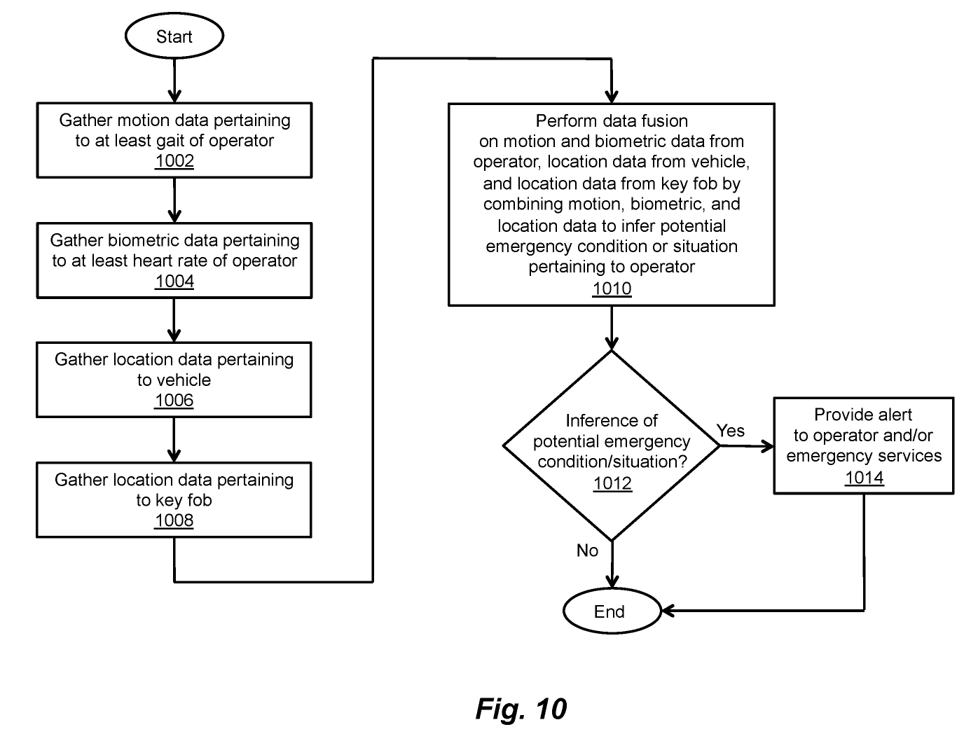

A further exemplary method of performing data fusion on motion data and/or biometric data pertaining to the automotive operator 101 wearing the wearable key fob 102, location data pertaining to the wireless keyless entry system 108, and/or location data pertaining to the automotive vehicle 104, in order to infer a potential emergency condition or situation pertaining to the automotive operator 101, is described herein with reference to FIG. 10, as well as FIGS. 1-3. It is noted that blocks 1002, 1004, 1006, and 1008 of FIG. 10 are like blocks 902, 904, 906, and 908 of FIG. 9, respectively, in which the motion data pertaining to the gait of the automotive operator 101 are gathered (see blocks 902 and 1002), the biometric data pertaining to the heart rate/heart rate variability of the automotive operator 101 are gathered (see blocks 904 and 1004), the location data pertaining to the automotive vehicle 104 are gathered (see blocks 906 and 1006), and the location data pertaining to the wearable key fob 102 are gathered (see blocks 908 and 1008). As depicted in block 1010 (see FIG. 10), a data fusion is performed, by the data fusion/decision engine 227 (see FIG. 2) of the wireless keyless entry system 108, by fusing or combining the gait motion data, the heart rate/heart rate variability data, the location data for the automotive vehicle 104 (see FIG. 1), and/or the location data for the wearable key fob 102 in order to infer the potential emergency condition or situation pertaining to the automotive operator 101. For example, such a potential emergency condition or situation may relate to a state of fatigue, a cardiac event, a traffic accident, or any other suitable medical and/or non-medical emergency condition or situation of the automotive operator 101. As depicted in block 1012, a determination is made as to whether or not the inference made about the automotive operator 101 relates to a potential emergency condition or situation. As depicted in block 1014, if the inference made about the automotive operator 101 is indicative of a potential emergency condition or situation, then (1) one or more of the operator alert mechanisms 316 (see FIG. 3) are activated, by the processor 304 of the vehicle telematics 110, to provide an audible and/or visible alert to the automotive operator 101, and/or (2) an alert is provided, by the processor 304 in conjunction with the transmitter/receiver 308 of the vehicle telematics 110, to appropriate emergency services personnel (e.g., “911” services). For example, such an alert provided to emergency services personnel may include the geographical location of the automotive vehicle 104, and/or the geographical location of the automotive operator 104 wearing the wearable key fob 102, to facilitate the location of the potential emergency condition or situation by the emergency services personnel.

Having described the above illustrative embodiments of the disclosed wireless keyless entry system, other alternative embodiments or variations may be made and/or practiced. For example, it was described herein that the geographical location of the automotive vehicle 104 (see FIG. 1) may be determined by the vehicle locator 302 (see FIG. 3) of the vehicle telematics 110 using the GPS receiver 322, and that the geographical location of the wireless keyless entry system 108 within the wearable key fob 102 may be determined by the key fob locator 212 (see FIG. 2) using the GPS receiver 234. In an alternative embodiment, such geographical locations of the automotive vehicle 104 and the wearable key fob 102 can be used by the wireless keyless entry system 108 to aid the automotive operator 104 in the task of finding the automotive vehicle 104 (e.g., in the event the automotive operator 101 has forgotten where she parked her car).

FIG. 11 depicts an illustrative embodiment of an exemplary partial view of the wearable key fob 102, including a housing 1101 and the display 1102. In one embodiment, the wearable key fob 102 may also include a plurality of pushbuttons 1110, 1112, 1114, and 1116 for use in locking one or more doors of the automotive vehicle 104, unlocking one or more doors of the automotive vehicle 104, opening a trunk or tailgate of the automotive vehicle 104, and sounding an alarm on the automotive vehicle 104, respectively. In this embodiment, the display 1102 of the wearable key fob 102 illustrates the operation of an exemplary application software program stored in the memory 206 and executed by the processor 204 of the wireless keyless entry system 108, showing relative geographical locations of the automotive operator 101 wearing the wearable key fob 102 (see reference numeral 1106; “Me”) and the automotive vehicle 104 (see reference numeral 1108; “Car”) on an exemplary map of city streets (“Main St.,” “Elm St.”). The wireless keyless entry system 108 running the exemplary application program can employ location data specifying the geographical location 1106 of the automotive operator 101 wearing the wearable key fob 102, and location data specifying the geographical location 1108 of the automotive vehicle 104, to provide graphical representations of such geographical locations 1106, 1108 in relation to the exemplary city street map. By using such an application program on the wearable key fob 102, the automotive operator 101 can easily determine that she (i.e., Me 1106) is currently located on Elm St., and that the automotive vehicle 104 (i.e., the Car 1108) is currently parked about one city block away on Main St.

It was further described herein that, in one embodiment, the automotive operator 101 can unlock one or more doors of the automotive vehicle 104 by manually activating a pushbutton (e.g., the pushbutton 1110; see FIG. 11) included in the wearable key fob 102. In an alternative embodiment, the automotive operator 101 may execute a vertical hand gesture (graphically illustrated by a directional arrow 122; see FIG. 1), a horizontal hand gesture (graphically illustrated by a directional arrow 124), and/or a circular hand gesture (graphically illustrated by directional arrows 126) to lock one or more doors of the automotive vehicle 104, to open a trunk or tailgate of the automotive vehicle 104, to sound an alarm on the automotive vehicle 104, or to perform any other suitable vehicle operational function(s). With the wearable key fob 102 strapped to the wrist of the automotive operator 101, the motion detector 214 (including the multi-axis accelerometer 236; see FIG. 2) of the wireless keyless entry system 108 can be configured to sense such vertical, horizontal, and/or circular hand gestures, which can be translated by the processor 204 of the wireless keyless entry system 108 into commands for transmission by the transmitter/receiver 208 over the wireless communication paths 112 to the vehicle telematics 110 in order to implement the desired vehicle operational functions.

Other alternative embodiments of the disclosed wireless keyless entry system can include suitable software programs to perform the steps and/or operations described in detail herein. One such embodiment comprises a computer program product that has a computer-storage medium (e.g., a non-transitory, tangible, computer-readable media, disparately located or commonly located storage media, computer storage media or medium, etc.) including computer program logic encoded thereon that, when performed in a computerized device having a processor and corresponding memory, programs the processor to perform (or causes the processor to perform) the operations described herein. Such arrangements are typically provided as software, firmware, microcode, code data (e.g., data structures), etc., arranged or encoded on a computer readable storage medium such as an optical medium (e.g., CD-ROM), floppy disk, hard disk, one or more ROM, RAM, or PROM chips, an application specific integrated circuit (ASIC), a field-programmable gate array (FPGA), and so on. The software, firmware, or other such configurations can be installed onto a computerized device to cause the computerized device to perform the techniques described herein. In addition, in one or more alternative embodiments, the functionality of the processor 204 of the wireless keyless entry system 108, as well as the functionality of the processor 304 of the vehicle telematics 110, can be implemented using an ASIC, an FPGA, a preprogrammed gate array, or any other suitable electronics configuration.

It is noted that the order of the various method blocks or steps, as described herein, has been presented for purposes of clarity of illustration. In general, such method blocks or steps can be performed in any suitable order. Also, it is to be understood that each of the systems, methods, apparatuses, etc., described herein can be embodied strictly as a software program, as a hybrid of software and hardware, or as hardware alone such as within a processor, within an operating system, or within a software application, or via a non-software application such as a user performing all or part of the operations.

It will be appreciated by those of ordinary skill in the art that further modifications to and variations of the above-described systems and methods may be made without departing from the inventive concepts described herein. Accordingly, the present application should not be viewed as limited except as by the scope and spirit of the appended claims.

What is claimed is:

1. A method of a wearable keyless entry system for an automotive vehicle, the wearable keyless entry system including a transmitter/receiver, the method comprising:
placing the transmitter/receiver in a non-transmitting state;
determining whether or not a user of the wearable keyless entry system is an authorized operator of the automotive vehicle;
in the event the user of the wearable keyless entry system is determined to be the authorized operator of the automotive vehicle:
transitioning the transmitter/receiver from the non-transmitting state to a transmitting/receiving state for wirelessly communicating with vehicle electronics of the automotive vehicle; and
transmitting, by the transmitter/receiver, a system identifier of the wearable keyless entry system to the vehicle electronics; and
in the event the user of the wearable keyless entry system is determined not to be the authorized operator of the automotive vehicle, maintaining the transmitter/receiver in the non-transmitting state.

2. The method of claim 1 wherein the wearable keyless entry system further includes one or more of (1) one or more biometric sensors for obtaining biometric data and (2) one or more motion sensors for obtaining motion data, and wherein the method further comprises:
obtaining one or more of the biometric data and the motion data pertaining to the user of the wearable keyless entry system.

3. The method of claim 2 wherein the obtaining of one or more of the biometric data and the motion data includes obtaining gait motion data pertaining to the user of the wearable keyless entry system.

4. The method of claim 3 wherein the determining of whether or not the user of the wearable keyless entry system is the authorized operator of the automotive vehicle includes:
calculating a gait signature of the user of the wearable keyless entry system;
comparing the calculated gait signature with a stored gait signature to determine a similarity of the respective calculated and stored gait signatures; and
determining whether or not the user of the wearable keyless entry system is the authorized operator of the automotive vehicle based on the similarity of the respective calculated and stored gait signatures.

5. The method of claim 2 wherein the obtaining of one or more of the biometric data and the motion data includes obtaining heart rate biometric data pertaining to the user of the wearable keyless entry system.

6. The method of claim 5 wherein the determining of whether or not the user of the wearable keyless entry system is the authorized operator of the automotive vehicle includes:
calculating a heart rate signature of the user of the wearable keyless entry system;
comparing the calculated heart rate signature with a stored heart rate signature to determine a similarity of the respective calculated and stored heart rate signatures; and
determining whether or not the user of the wearable keyless entry system is the authorized operator of the automotive vehicle based on the similarity of the respective calculated and stored heart rate signatures.

7. The method of claim 2 wherein the obtaining of one or more of the biometric data and the motion data includes obtaining heart rate biometric data pertaining to the user of the wearable keyless entry system, and obtaining gait motion data pertaining to the user of the wearable keyless entry system.

8. The method of claim 7 wherein the determining of whether or not the user of the wearable keyless entry system is the authorized operator of the automotive vehicle further includes:
performing a data fusion on the heart rate biometric data and the gait motion data to infer, in accordance with predetermined decision criteria, that the user of the wearable keyless entry system is the authorized operator of the automotive vehicle, the predetermined decision criteria being based on a first degree of similarity between a calculated heart rate signature and a stored heart rate signature, and a second degree of similarity between a calculated gait signature and a stored gait signature, the calculated heart rate signature being based on the heart rate biometric data, and the calculated gait signature being based on the gait motion data.

9. A method of a wearable keyless entry system for an automotive vehicle, the wearable keyless entry system including a transmitter/receiver, and a system location locator for obtaining user location data specifying one or more geographical locations of a user of the wearable keyless entry system, the method comprising:
obtaining the user location data specifying the one or more geographical locations of the user of the wearable keyless entry system;
accessing, via the transmitter/receiver, vehicle location data from a data storage resource of a processing cloud, the vehicle location data specifying a geographical location of the automotive vehicle;
determining whether or not the user location data and the vehicle location data satisfy at least one predetermined distance criteria; and
having determined that the at least one predetermined distance criteria is satisfied by the user location data and the vehicle location data, transmitting, by the transmitter/receiver, a system identifier of the wearable keyless entry system to vehicle electronics of the automotive vehicle.

10. The method of claim 9 wherein the accessing of the vehicle location data from the data storage of the processing cloud is performed while avoiding a possible transmission of the system identifier of the wearable keyless entry system.

11. The method of claim 9 wherein the at least one predetermined distance criteria is based on a proximity of the user of the wearable keyless entry system to the automotive vehicle, and wherein the determining of whether or not the user location data and the vehicle location data satisfy the at least one predetermined distance criteria includes comparing the proximity of the user of the wearable keyless entry system to the automotive vehicle with predetermined threshold criteria.

12. The method of claim 9 wherein the at least one predetermined distance criteria is based on a movement direction of the user of the wearable keyless entry system relative to the automotive vehicle, and wherein the determining of whether or not the user location data and the vehicle location data satisfy the at least one predetermined distance criteria includes comparing the movement direction of the user of the wearable keyless entry system relative to the automotive vehicle with predetermined threshold criteria.

13. The method of claim 9 wherein the determining of whether or not the user location data and the vehicle location data satisfy the at least one predetermined distance criteria includes:
performing a data fusion on the user location data and the vehicle location data to infer, in accordance with predetermined decision criteria, that the user of the wearable keyless entry system is one of near, approaching, and departing from the automotive vehicle, the predetermined decision criteria being based on a particular venue where one or more of the automotive vehicle and the user of the wearable keyless entry system are located, the predetermined distance criteria being based at least in part on the particular venue.

14. A method of a wearable keyless entry system for an automotive vehicle, comprising:
generating an operator profile of a user of the wearable keyless entry system, the operator profile including at least an operator identifier of the user; and
storing the operator profile in a data storage resource of a processing cloud, the data storage resource further storing a vehicle profile of the automotive vehicle, the vehicle profile including at least one or more operator identifiers, and personalized vehicle settings corresponding to each respective operator identifier, a data fusion/decision processing resource of the processing cloud performing data fusion/decision processing on the operator profile and the vehicle profile based on the operator identifier of the user to obtain the personalized vehicle settings corresponding to the operator identifier of the user, and initiating a transmission of the personalized vehicle settings of the user to vehicle electronics of the automotive vehicle.

15. The method of claim 14 wherein the wearable keyless entry system has an associated system identifier, and wherein the storing of the operator profile in the data storage resource of the processing cloud includes avoiding a possible transmission of the system identifier of the wearable keyless entry system.

16. A method of a wearable keyless entry system for an automotive vehicle, comprising:
generating a user profile of a user of the wearable keyless entry system, the user profile including at least user location data and one or more of user biometric data and user motion data;
storing the user profile in a data storage resource of a processing cloud, the data storage resource further storing a vehicle profile of the automotive vehicle, the vehicle profile including vehicle location data, a data fusion/decision processing resource of the processing cloud performing data fusion/decision processing on the user profile and the vehicle profile to determine one or more of (1) one or more destination locations of the automotive vehicle, and (2) one or more activities of the user of the wearable keyless entry system; and
receiving, at one of the wearable keyless entry system and vehicle electronics of the automotive vehicle, one or more of personalized targeted advertisement data and personalized targeted service data pertaining to one or more of the one or more destination locations and the one or more activities.

17. The method of claim 16 wherein the wearable keyless entry system has an associated system identifier, and wherein the storing of the user profile in the data storage resource of the processing cloud includes avoiding a possible transmission of the system identifier of the wearable keyless entry system.

18. A wearable keyless entry system having an associated system identifier, the wearable keyless entry system comprising:
a transmitter/receiver, the transmitter/receiver initially being in a non-transmitting state; and
a processor operative:
to determine whether or not a user of the wearable keyless entry system is an authorized operator of the automotive vehicle; and
in the event the user of the wearable keyless entry system is determined to be the authorized operator of the automotive vehicle, to transition the transmitter/receiver from the non-transmitting state to a transmitting/receiving state for wirelessly communicating with vehicle electronics of the automotive vehicle,
wherein the transmitter/receiver is operative, having transitioned to the transmitting/receiving state, to transmit the system identifier to the vehicle electronics; and
wherein the processor is further operative, in the event the user of the wearable keyless entry system is determined not to be the authorized operator of the automotive vehicle, to maintain the transmitter/receiver in the non-transmitting state.

19. The wearable keyless entry system of claim 18 further comprising:
one or more of (1) one or more biometric sensors operative to obtain biometric data and (2) one or more motion sensors operative to obtain motion data, the biometric data and the motion data pertaining to the user of the wearable keyless entry system.

20. The system of claim 19 wherein the one or more motion sensors are operative to obtain gait motion data pertaining to the user of the wearable keyless entry system.

21. The system of claim 20 wherein the processor is further operative:
to calculate a gait signature of the user of the wearable keyless entry system using the gait motion data;
to compare the calculated gait signature with a stored gait signature to determine a similarity of the respective calculated and stored gait signatures; and
to determine whether or not the user of the wearable keyless entry system is the authorized operator of the automotive vehicle based on the similarity of the respective calculated and stored gait signatures.

22. The system of claim 19 wherein the one or more biometric sensors are operative to obtain heart rate biometric data pertaining to the user of the wearable keyless entry system.

23. The system of claim 22 wherein the processor is further operative:
to calculate a heart rate signature of the user of the wearable keyless entry system;
to compare the calculated heart rate signature with a stored heart rate signature to determine a similarity of the respective calculated and stored heart rate signatures; and
to determine whether or not the user of the wearable keyless entry system is the authorized operator of the automotive vehicle based on the similarity of the respective calculated and stored heart rate signatures.

24. The system of claim 19 wherein the one or more motion sensors are operative to obtain gait motion data pertaining to the user of the wearable keyless entry system, and wherein the one or more biometric sensors are operative to obtain heart rate biometric data pertaining to the user of the wearable keyless entry system.

25. The system of claim 24 wherein the processor is further operative:
to perform a data fusion on the heart rate biometric data and the gait motion data to infer, in accordance with predetermined decision criteria, that the user of the wearable keyless entry system is the authorized operator of the automotive vehicle, the predetermined decision criteria being based on a first degree of similarity between a calculated heart rate signature and a stored heart rate signature, and a second degree of similarity between a calculated gait signature and a stored gait signature, the calculated heart rate signature being based on the heart rate biometric data, and the calculated gait signature being based on the gait motion data.

26. The system of claim 18 further comprising:
a housing configured to house the transmitter/receiver, and the processor,
wherein the housing is configured as part of one of a wearable key fob, an armband, a headband, a chest band, a bracelet, a necklace, and a device attachable to an article of clothing.

27. The system of claim 18 wherein the processor is implemented as one of a microprocessor, a microcontroller, an application-specific integrated circuit (ASIC), and a gate array.
